(19) United States
(12) Patent Application Publication
(10) Pub. No.: US 2016/0370512 A1
(43) Pub. Date: Dec. 22, 2016

(54) LIGHT DIFFUSING MEMBER AND DISPLAY DEVICE

(71) Applicant: SHARP KABUSHIKI KAISHIA, Osaka-shi (JP)

(72) Inventors: Emi YAMAMOTO, Osaka-shi (JP); Tsuyoshi MAEDA, Osaka-shi (JP); Yasushi ASAOKA, Osaka-shi (JP); Shohei KATSUTA, Osaka-shi (JP); Hideomi YUI, Osaka-shi (JP)

(21) Appl. No.: 14/902,380

(22) PCT Filed: Jun. 26, 2014
(86) PCT No.: PCT/JP2014/067068

§ 371 Date: Dec. 31, 2015

(30) Foreign Application Priority Data
Jul. 4, 2013 (JP) 2013-141142

(51) Int. Cl. G02B 5/02; G02F 1/13363; G02F 1/1335

(52) U.S. Cl. CPC G02B 5/0278; G02B 5/0242; G02B 5/0247; G02F 1/133504; G02F 1/13363; G02F 2001/133562

(57) ABSTRACT

A light diffusing film (a light diffusing member) according to the present invention includes a substrate which has optical transparency and a birefringence, a wavelength control layer which is formed one surface of the substrate, a light diffusing portion which is formed in a region other than a forming region of the wavelength control layer in the one surface of the substrate, and a light scattering layer, the light diffusing portion includes a light emitting end surface which comes into contact with the substrate and a light incident end surface which is opposite to the light emitting end surface and has a larger area than an area of the light emitting end surface, and a height from the light incident end surface to the light emitting end surface is larger than a layer thickness of the wavelength control layer.

### TECHNICAL FIELD

The present invention relates to a light diffusing member and a display device.

The present application claims priority based on Japanese Patent Application 2013-141142 which was filed in Japan on Jul. 4, 2013 and contents thereof are incorporated herein.

### BACKGROUND ART

A liquid crystal display device has been widely used as a display of a portable electronic device including a portable telephone, or a television, a personal computer, and the like. In general, a liquid crystal display device has excellent viewability from the front, while a viewing angle thereof is narrow. Therefore, various kinds of ideas to widen a viewing angle have been provided. As one of the ideas, such configuration has been proposed that a member for controlling a diffusion angle of light which is emitted from a display body such as a liquid crystal panel (hereinafter, referred to as a light diffusing member) is provided on a viewing side of the display body.

For example, a light diffusing sheet in which a groove having a V-shaped section is provided on a light diffusing layer and a light absorption layer is provided on a portion of the groove is disclosed in following PTL 1. In the light diffusing sheet, a transparent sheet made of polyethylene terephthalate (PET) or the like is disposed on a light incident side and a light emitting side of the light diffusing layer. Part of light orthogonally incident on the light diffusing layer is totally reflected on a wall surface of the groove and then emitted. Accordingly, light emitted from the light diffusing sheet is diffused.

### CITATION LIST

### Patent Literature

PTL 1: Japanese Unexamined Patent Application Publication No. 2000-352608

### SUMMARY OF INVENTION

### Technical Problem

In general, a transparent sheet which is made of PET or the like and is used in the above-described light diffusing sheet has a retardation from 1000 nm to 4000 nm in a plane thereof due to extending processing in production. Therefore, in a case where this type of light diffusing sheet is disposed on the light emitting side of a liquid crystal display device, a retardation is generated in light incident on the light diffusing sheet due to a transparent sheet having a birefringence and the light is divided into P polarized light and S polarized light. As a result, reflectances of P polarized light and S polarized light are different from each other on an interface between the transparent sheet and air, so that a ratio of color light in light emitted from the light diffusing sheet varies depending on an observation angle and unevenness like a rainbow is seen. Hereinafter, this unevenness is referred to as “iridescent unevenness”. There has been a problem in which viewability is degraded due to this iridescent unevenness.

One aspect of the present invention is offered to solve the above-mentioned problem of related art and one of objects is to provide a display device which is provided with a light diffusing member which suppresses an occurrence of iridescent unevenness and exhibits an excellent viewing angle characteristic and such light diffusing member.

### Solution to Problem

In order to attain the above-mentioned object, a light diffusing member according to the present invention includes a substrate which has optical transparency and a birefringence, a wavelength control layer which is formed one surface of the substrate, a light diffusing portion which is formed in a region other than a forming region of the wavelength control layer in the one surface of the substrate, and a light scattering portion, in which the light diffusing portion includes a light emitting end surface which comes into contact with the substrate and a light incident end surface which is opposite to the light emitting end surface and has a larger area than an area of the light emitting end surface, and a height from the light incident end surface to the light emitting end surface is larger than a layer thickness of the wavelength control layer. Here, the “light diffusing portion which is formed in a region other than a forming region of the wavelength control layer in the one surface of the substrate” includes a light diffusing portion which is formed approximately in a region other than a forming region of the wavelength control layer. The “light diffusing portion which is formed approximately in a region other than a forming region of the wavelength control layer” represents to include a light diffusing portion which is formed in a state a portion thereof is overlapped with the wavelength control layer.

In the light diffusing member according to one aspect of the present invention, an in-plane retardation of the substrate may be from 1000 nm to 4000 nm.

In the light diffusing member according to one aspect of the present invention, the light scattering portion may be provided on the other surface side which is opposite to the one surface of the substrate.

In the light diffusing member according to one aspect of the present invention, the light scattering portion may serve also as an antiglare treatment layer.

A display device according to one aspect of the present invention includes a display body, and a viewing angle extending member which is provided on a viewing side of the display body and emits light in a state in which angle distribution of light which is incident from the display body is extended more than before the light is incident. The display device is composed of a light diffusing member in which the viewing angle extending member includes a substrate which has optical transparency and a birefringence, a wavelength control layer which is formed one surface of the substrate, a light diffusing portion which is formed in a region other than a forming region of the wavelength control layer in the one surface of the substrate, and a light scattering portion, the light diffusing portion includes a light emitting end surface which comes into contact with the substrate and a light incident end surface which is opposite to the light emitting end surface and has a larger area than an area of the light emitting end surface, and a height from the light incident end surface to the light emitting end surface is larger than a layer thickness of the wavelength control layer. The light scattering portion is disposed on any position on a light emitting surface side more than the display body.

### Advantageous Effects of Invention

According to one aspect of the present invention, a display device which is provided with a light diffusing member which suppresses an occurrence of iridescent unevenness and exhibits an excellent viewing angle characteristic or such light diffusing member can be provided.

### BRIEF DESCRIPTION OF DRAWINGS

FIG. 1(A) is a perspective view illustrating a liquid crystal display device according to a first embodiment and FIG. 1(B) is a sectional view illustrating the liquid crystal display device according to the first embodiment.

FIG. 2 is a sectional view illustrating a liquid crystal panel in the liquid crystal display device according to the first embodiment.

FIG. 3 is a schematic view illustrating an action of a light diffusing film according to the first embodiment.

FIG. 4 is a sectional view illustrating the light diffusing film in the liquid crystal display device according to the first embodiment.

FIG. 5 is a perspective view illustrating the light diffusing film of the liquid crystal display device while following the order of a manufacturing process according to the first embodiment.

FIGS. 6(A) and (B) illustrate a relation between emitted light from a backlight and a lateral surface of the light diffusing portion.

FIGS. 7(A) and (B) illustrate a mechanism of an occurrence of iridescent unevenness.

FIGS. 8(A) to (C) are graphs illustrating simulation results of the intensity of light emitted from a birefringence substrate.

FIG. 9(A) is a perspective view illustrating a liquid crystal display device according to a second embodiment and FIG. 9(B) is a sectional view illustrating the liquid crystal display device according to the first embodiment.

FIG. 10 is a perspective view illustrating a light diffusing film of the liquid crystal display device according to the second embodiment while following the order of a manufacturing process.

FIG. 11 illustrates a disposition relation between a pixel of a liquid crystal panel and a pattern of a wavelength control layer.

FIG. 12 is a perspective view illustrating an example of a manufacturing device for a light control member.

FIG. 13 is a perspective view illustrating chief parts of the manufacturing device for a light control member.

FIG. 14 is a perspective view illustrating a light diffusing film according to a third embodiment.

FIG. 15 is a sectional view illustrating a liquid crystal display device according to a fourth embodiment.

FIG. 16 is a sectional view illustrating a liquid crystal display device according to a fifth embodiment.

FIG. 17 is a sectional view illustrating a liquid crystal display device according to a sixth embodiment.

FIG. 18 is a sectional view illustrating a liquid crystal display device according to a seventh embodiment.

FIG. 19 is a sectional view illustrating a liquid crystal display device according to an eighth embodiment.

### DESCRIPTION OF EMBODIMENTS

### First Embodiment

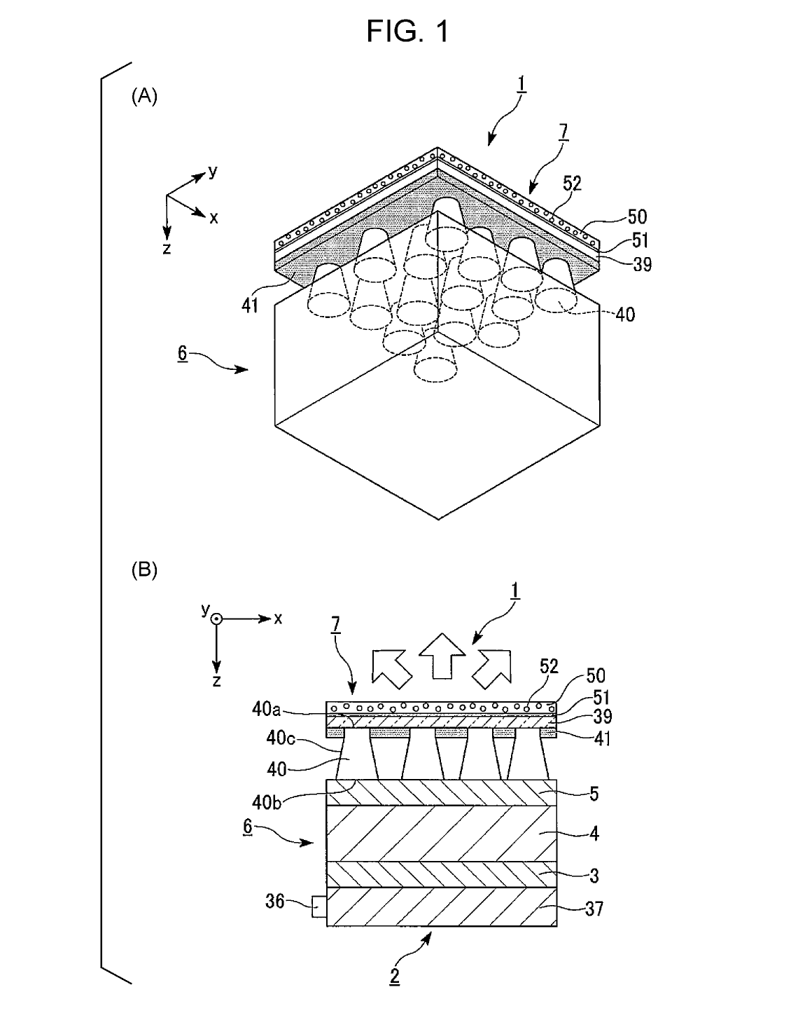

A first embodiment of the present invention is described below with reference to FIGS. 1 to 5.

In this embodiment, an example of a liquid crystal display device which is provided with a transmission type liquid crystal panel as a display body is described. Here, in all of the following drawings, reduction scales of dimensions may be varied depending on the constituent elements so as to facilitate visualization of respective constituent elements.

FIGS. 1(A) and (B) are schematic views illustrating a liquid crystal display device according to this embodiment. FIG. 1(A) is a perspective view in which a liquid crystal display device 1 according to this embodiment is viewed from an obliquely downward direction (back face side). FIG. 1(B) is a sectional view illustrating the liquid crystal display device 1 according to this embodiment.

The liquid crystal display device 1 according to this embodiment (a display device) is composed of a liquid crystal display body 6 (a display body) which includes a backlight 2 (a light source), a first polarizer 3, a liquid crystal panel 4 (a light modulation element), and a second polarizer 5 and a light diffusing film 7 (a light diffusing member), as illustrated in FIGS. 1(A) and (B).

Though the liquid crystal panel 4 is schematically illustrated like a plate in FIG. 1(B), the detailed configuration thereof will be described later. An observer observes a display from an upper side, on which the light diffusing film 7 is disposed, of the liquid crystal display device 1 of FIG. 1(B). Therefore, a side on which the light diffusing film 7 is disposed is referred to as a viewing side and a side on which the backlight 2 is disposed is referred to as a back face side in the following description.

In the liquid crystal display device 1 according to this embodiment, light emitted from the backlight 2 is modulated in the liquid crystal panel 4 so as to display predetermined images, letters, and the like by the modulated light. When light emitted from the liquid crystal panel 4 is transmitted through the light diffusing film 7, the light is emitted from the light diffusing film 7 in a state in which angle distribution of the emitted light is wider than that before the light is incident on the light diffusing film 7. Accordingly, the observer can visually recognize the display with a wider viewing angle.

That is, the light diffusing film 7 functions as a viewing angle extending member.

The specific configuration of the liquid crystal panel 4 is described below. A transmission type liquid crystal panel of the active matrix system is described as an example here. However, a liquid crystal panel applicable to the present invention is not limited to the transmission type liquid crystal panel of the active matrix system. A liquid crystal panel applicable to the present invention may be a transflective type (transmission/reflection type) liquid crystal panel or a reflection type liquid crystal panel, for example, and further may be a liquid crystal panel of the passive matrix system in which each pixel is not provided with a thin film transistor (hereinafter, abbreviated to a TFT) for switching.

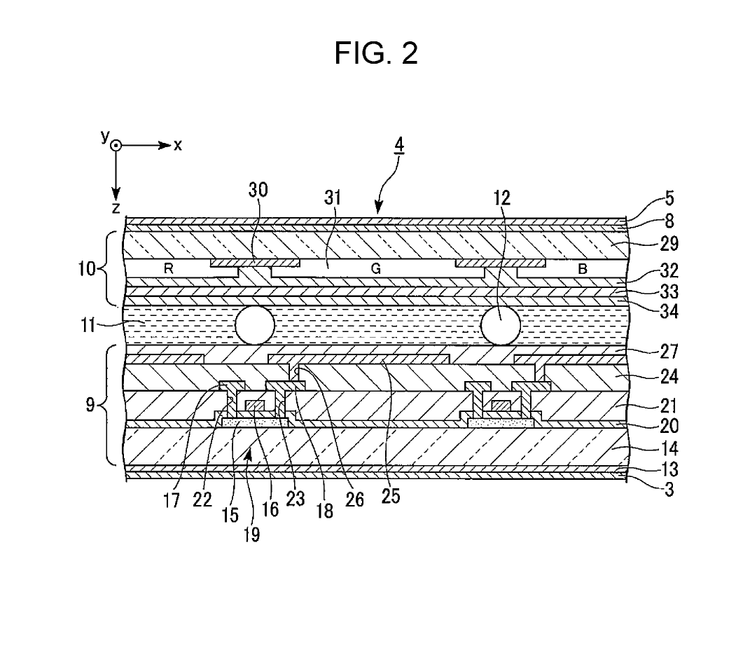

FIG. 2 is a longitudinal sectional view illustrating the liquid crystal panel 4.

The liquid crystal panel 4 includes a TFT substrate 9 serving as a switching element substrate, a color filter substrate 10 which is disposed to be opposed to the TFT substrate 9, and a liquid crystal layer 11 which is interposed and held between the TFT substrate 9 and the color filter substrate 10, as illustrated in FIG. 2. The liquid crystal layer 11 is sealed in a space which is surrounded by the TFT substrate 9, the color filter substrate 10, and a frame-shaped sealing member (not illustrated) for bonding the TFT substrate 9 and the color filter substrate 10 to each other with a predetermined interval.

The liquid crystal panel 4 provides display in a vertical alignment (VA) mode, for example, and vertical alignment liquid crystal of negative dielectric constant anisotropy is used for the liquid crystal layer 11.

Between the TFT substrate 9 and the color filter substrate 10, column-shaped spacers 12 for maintaining the interval between these substrates constant are disposed. Here, the display mode is not limited to the above-mentioned VA mode, but a twisted nematic (TN) mode, a super twisted nematic (STN) mode, an in-plane switching (IPS) mode, and the like may be used.

In the TFT substrate 9, a plurality of pixels (not illustrated) which are the minimum unit regions of display are arranged in a matrix. In the TFT substrate 9, a plurality of source bus lines (not illustrated) are formed to extend parallel to each other and a plurality of gate bus lines (not illustrated) are formed to extend parallel to each other and to be orthogonal to a plurality of source bus lines. On the TFT substrate 9, a plurality of source bus lines and a plurality of gate bus lines are formed in a lattice shape and a rectangular region which is sectioned by adjacent source bus lines and adjacent gate bus lines constitutes one pixel. The source bus line is connected to a source electrode of a TFT which will be described later and the gate bus line is connected to a gate electrode of the TFT.

On a surface, which is on the liquid crystal layer 11 side, of a transparent substrate 14 constituting the TFT substrate 9, a TFT 19 which includes a semiconductor layer 15, a gate electrode 16, a source electrode 17, a drain electrode 18, and the like is formed. As the transparent substrate 14, a glass substrate can be used, for example. On the transparent substrate 14, the semiconductor layer 15 which is made of a semiconductor material such as continuous grain silicon (CGS), low-temperature poly-silicon (LPS), and amorphous silicon (α-Si) is formed.

On the transparent substrate 14, a gate insulation film 20 is formed to cover the semiconductor layer 15. As a material of the gate insulation film 20, a silicon oxide film, a silicon nitride film, or a laminated film of a silicon oxide film and a silicon nitride film can be used, for example. On the gate insulation film 20, the gate electrode 16 is formed to be opposed to the semiconductor layer 15. As a material of the gate electrode 16, a laminated film of tungsten (W)/tantalum nitride (TaN), molybdenum (Mo), titanium (Ti), aluminum (Al), or the like is used, for example.

On the gate insulation film 20, a first interlayer insulation film 21 is formed to cover the gate electrode 16. As a material of the first interlayer insulation film 21, a silicon oxide film, a silicon nitride film, or a laminated film of a silicon oxide film and a silicon nitride film can be used, for example.

On the first interlayer insulation film 21, the source electrode 17 and the drain electrode 18 are formed. The source electrode 17 is connected to a source region of the semiconductor layer 15 via a contact hole 22 which penetrates through the first interlayer insulation film 21 and the gate insulation film 20. In a similar manner, the drain electrode 18 is connected to a drain region of the semiconductor layer 15 via a contact hole 23 which penetrates through the first interlayer insulation film 21 and the gate insulation film 20. As a material of the source electrode 17 and the drain electrode 18, a conductive material similar to that of the above-described gate electrode 16 can be used. On the first interlayer insulation film 21, a second interlayer insulation film 24 is formed to cover the source electrode 17 and the drain electrode 18. As a material of the second interlayer insulation film 24, a material similar to that of the above-described first interlayer insulation film 21 or an organic insulating material can be used.

On the second interlayer insulation film 24, a pixel electrode 25 is formed. The pixel electrode 25 is connected to the drain electrode 18 via a contact hole 26 which penetrates through the second interlayer insulation film 24. Accordingly, the pixel electrode 25 is connected to the drain region of the semiconductor layer 15 by using the drain electrode 18 as a relay electrode. As a material of the pixel electrode 25, a transparent conductive material such as indium tin oxide (ITO) and indium zinc oxide (IZO) can be used, for example. By this configuration, a scanning signal is supplied through the gate bus line, and when the TFT 19 is turned on, an image signal which is supplied to the source electrode 17 through the source bus line is supplied to the pixel electrode 25 via the semiconductor layer 15 and the drain electrode 18. Further, an alignment film 27 is formed on the whole surface on the second interlayer insulation film 24 in a manner to cover the pixel electrode 25. This alignment film 27 has an alignment anchoring force to vertically align liquid crystal particles which constitute the liquid crystal layer 11. Here, as the configuration of the TFT, the top gate type TFT illustrated in FIG. 2 or a bottom gate type TFT may be employed.

On a surface, which is on the liquid crystal layer 11 side, of a transparent substrate 29 constituting the color filter substrate 10, a black matrix 30, a color filter 31, a planarization layer 32, a counter electrode 33, and an alignment film 34 are formed in sequence. The black matrix 30 has a function to shield transmission of light in a region between pixels. The black matrix 30 is made of metal such as chrome (Cr) and a multilayer film of Cr and Cr oxide, or a photo resist in which carbon particles are dispersed in photosensitive resin, for example.

In the color filter 31, coloring matters of each color among red (R), green (G), and blue (B) are contained. Any one of the color filters 31 of R, G, and B is disposed to be opposed to one pixel electrode 25 provided on the TFT substrate 9. Here, the color filters 31 may have the multi-color configuration of more than three colors of R, G, and B.

The planarization layer 32 is composed of an insulation film which covers the black matrix 30 and the color filter 31. The planarization layer 32 has a function to reduce and planarize a level difference which is made by the black matrix 30 and the color filter 31. On the planarization layer 32, the counter electrode 33 is formed. As a material of the counter electrode 33, a transparent conductive material similar to that of the pixel electrode 25 is used. On the whole surface on the counter electrode 33, the alignment film 34 having the vertical alignment anchoring force is formed.

Referring back to FIG. 1(B), the backlight 2 includes a light source 36 such as a light emitting diode and a cold-cathode tube and a light guide 37 which emits light toward the liquid crystal panel 4 by using internal reflection of the light emitted from the light source 36. The backlight 2 may be an edge light type in which the light source 36 is disposed on an end surface of the light guide 37 or a direct under type in which the light source is disposed directly under the light guide. As the backlight 2 used in this embodiment, it is preferable to use a backlight which controls an emitting direction of light to allow the light to have directivity, as it is called, a directional backlight. The use of the directional backlight which makes collimated or approximately-collimated light incident on a light diffusing portion of the light diffusing film 7 which will be described later enables blur reduction and enhancement of light use efficiency. The above-mentioned directional backlight can be realized by optimizing a shape and an arrangement of a reflection pattern which is formed in the light guide 37. Alternatively, directivity may be realized by disposing a louver on the backlight 2. Between the backlight 2 and the liquid crystal panel 4, the first polarizer 3 functioning as a polarizer is provided. Between the liquid crystal panel 4 and the light diffusing film 7, the second polarizer 5 functioning as a polarizer is provided.

The light diffusing film 7 is now described in detail.

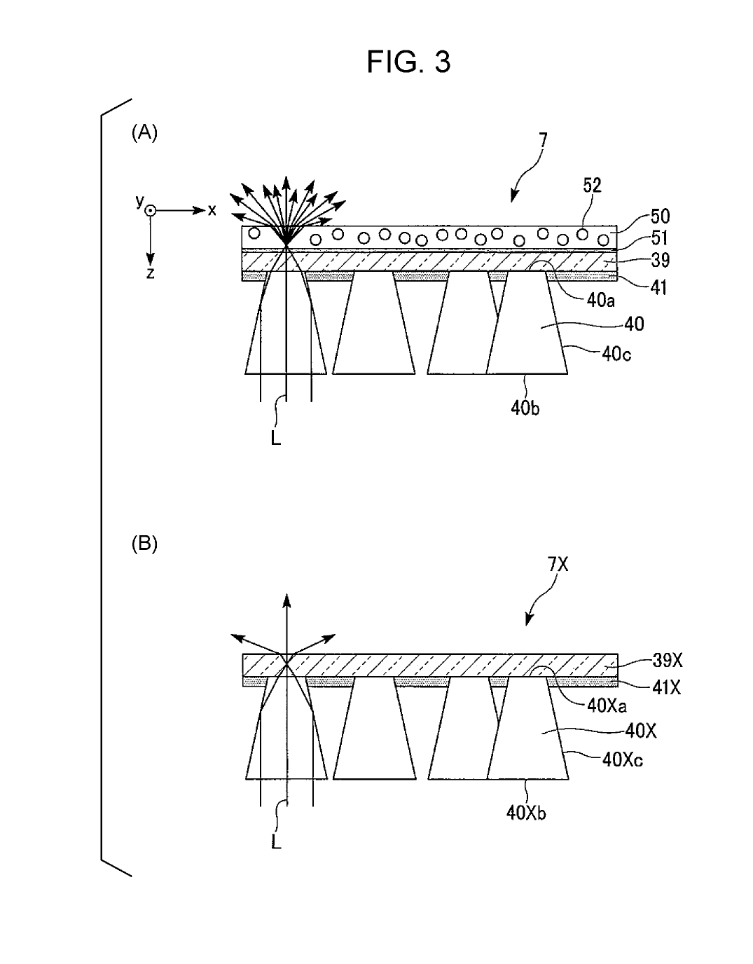

FIG. 3(A) is a sectional view illustrating the light diffusing film 7.

As illustrated in FIGS. 1(A) and (B) and FIG. 3(A), the light diffusing film 7 is composed of a substrate 39, a plurality of light diffusing portions 40 which are formed on one surface (a surface opposite to the viewing side) of the substrate 39, a wavelength control layer 41 which is formed on one surface of the substrate 39, and a light scattering layer 50 which is fixed on the other surface (a surface on the viewing side) with an adhesive layer 51 interposed. The light diffusing film 7 is disposed on the second polarizer 5 in such a posture that a side on which the light diffusing portions 40 are provided faces the second polarizer 5 and a side on which the substrate 39 is provided faces the viewing side, as illustrated in FIG. 1(B).

The substrate 39 is generally made of resins such as thermoplastic polymer, thermosetting resin, and photopolymerizable resin or the like. The substrate 39 has optical transparency and a birefringence. For the substrate 39, a substrate made of various types of transparent resin such as acrylic polymer, olefin polymer, vinyl polymer, cellulose polymer, amide polymer, fluorine polymer, urethane polymer, silicon polymer, and imide polymer can be used. For example, a transparent resin substrate such as a triacetyl cellulose (TAC) film, a polyethylene terephthalate (PET) film, a cycloolefin polymer (COP) film, a polycarbonate (PC) film, a polyethylene naphthalate (PEN) film, a polyether sulfone (PES) film, and a polyimide (PI) film is preferably used.

The substrate 39 serves as a base when materials of the wavelength control layer 41 and the light diffusing portions 40 are later applied in the later-described manufacturing process. From this perspective, the substrate 39 is required to have heat resistance, mechanical strength, chemical resistance, and the like for a heat treatment step in the manufacturing process. As the substrate 39, it is preferable to use a polyethylene terephthalate (PET) film, a polyethylene naphthalate (PEN) film, or the like. In the light of the low cost, it is more preferable to use a PET film. In this embodiment, a PET film the thickness of which is 100 μm is used as an example.

The light diffusing portion 40 is made of an organic material having optical transparency and photosensitivity such as acrylic resin, epoxy resin, and silicon resin. Mixture made of transparent resin and obtained by mixing a polymerization initiator, a coupling agent, a monomer, an organic solvent, or the like with these resins can be used. Further, the polymerization initiator may contain various types of additional components such as a stabilizer, an inhibitor, a plasticizer, a fluorescent brightener, a release agent, a chain transfer agent, and other photopolymerizable monomers. Furthermore, materials described in Japanese Patent No. 4129991 can be used. A total light transmittance of the light diffusing portion 40 is preferably 90% or more in accordance with the regulation of JIS K7361-1. When the total light transmittance is 90% or more, sufficient transparency can be obtained.

A horizontal section obtained when the light diffusing portion 40 is cut at a plane (an xy plane) parallel to one surface of the substrate 39 has a circular shape. A diameter of the light diffusing portion 40 is approximately 20 μm, for example. All of a plurality of light diffusing portions 40 have diameters identical to each other. In the light diffusing portion 40, a horizontal section which is on the substrate 39 side and is a light emitting end surface 40a has a smaller area and the area of the horizontal section gradually increases as separating from the substrate 39. That is, the light diffusing portion 40 has a so-called reverse-tapered circular truncated cone shape when viewed from the substrate 39 side.

The light diffusing portion 40 contributes to transmission of light in the light diffusing film 7. That is, light incident on the light diffusing portion 40 is guided in a state in which the light is approximately sealed in the inside of the light diffusing portion 40 while totally reflecting on a tapered lateral surface 40c of the light diffusing portion 40, and is emitted.

As illustrated in FIG. 1(A), a plurality of light diffusing portions 40 are arranged on the substrate 39 in a dotted manner. A plurality of light diffusing portions 40 are formed on the substrate 39 in a dotted manner and the wavelength control layer 41 is continuously formed on the substrate 39 in an integrated manner.

A plurality of light diffusing portions 40 are arranged at random (aperiodically) when viewed from a normal line direction of a principal surface of the substrate 39. Accordingly, pitches between adjacent light diffusing portions 40 are not even. An average pitch obtained by averaging pitches between adjacent light diffusing portions 40 is set to 25 μm, for example.

As illustrated in FIGS. 1(A) and (B) and FIG. 3(A), the wavelength control layer 41 is formed in a region other than forming regions of a plurality of light diffusing portions 40 in the surface on a side, on which the light diffusing portions 40 are formed, of the substrate 39. The wavelength control layer 41 is made of an organic material which has a light absorption property and photosensitivity such as a black resist as an example. Other than this, for the wavelength control layer 41, a material having a light shielding property, such as a metal simple substance such as chrome (Cr) and Cr/Cr oxide, metal oxide, a metal film such as a multilayer film composed of a metal simple substance and metal oxide, a pigment and a dye which are used in a black ink, black resin, a black ink obtained by mixing inks of many colors, and these types of ink further containing an ultraviolet absorber, may be used.

The layer thickness of the wavelength control layer 41 is set to be smaller than the height from a light incident end surface 40b to the light emitting end surface 40a of the light diffusing portion 40. In the case of the present embodiment, the layer thickness of the wavelength control layer 41 is approximately 150 nm as an example. The height from the light incident end surface 40b to the light emitting end surface 40a of the light diffusing portion 40 is approximately 20 μm as an example. In a space among a plurality of light diffusing portions 40, the wavelength control layer 41 exists in a portion which comes into contact with one surface of the substrate 39 and air exists in other portions.

It is preferable that a refractive index of the substrate 39 and a refractive index of the light diffusing portion 40 are approximately equivalent to each other. This is because if the refractive index of the substrate 39 and the refractive index of the light diffusing portion 40 are largely different from each other, for example, such defects that a desired light diffusion angle cannot be obtained and the light quantity of emitted light is reduced, for example, may arise due to an occurrence of unwanted light refraction or reflection in an interface between the light diffusing portion 40 and the substrate 39 when light incident from the light incident end surface 40b is emitted from the light diffusing portion 40.

The light diffusing film 7 is disposed so that the substrate 39 faces the viewing side as illustrated in FIG. 1(B). Therefore, between two counter surfaces of the light diffusing portion 40 having the circular truncated cone shape, a surface having a smaller area is the light emitting end surface 40a and a surface having a larger area is the light incident end surface 40b. An inclination angle of the lateral surface 40c of the light diffusing portion 40 (an angle made by the light emitting end surface 40a and the lateral surface 40c) is approximately 82° as an example. However, the inclination angle of the lateral surface 40c of the light diffusing portion 40 is not especially limited as long as the angle permits sufficient diffusion of incident light when the light is emitted from the light diffusing film 7.

Air exists between adjacent light diffusing portions 40. Therefore, if the light diffusing portions 40 are made of acrylic resin, for example, the lateral surface 40c of the light diffusing portion 40 is an interface between the acrylic resin and air. Even if the periphery of the light diffusing portions 40 is filled with other materials having a low refractive index, the refractive index difference on an interface between the inside and the outside of the light diffusing portion 40 reaches the maximum in a case where air exists in the outside among cases where any materials having a low refractive index exist. Accordingly, in the configuration of the present embodiment, a critical angle reaches the smallest and an incident angle range in which light totally reflects on the lateral surface 40c of the light diffusing portion 40 reaches the largest in accordance with the Snell's law. Consequently, a loss of light is more suppressed and high luminance can be obtained.

Here, light incident at an angle which is largely deviated from 90 degrees with respect to the light incident end surface 40b of the light diffusing portion 40 is incident at an angle which is equal to or smaller than a critical angle with respect to the lateral surface 40c of the light diffusing portion 40 and is transmitted through the lateral surface 40c of the light diffusing portion 40 without totally reflecting. However, the wavelength control layer 41 is provided in a region other than the forming regions of the light diffusing portions 40, so that light which is transmitted through the lateral surface 40c of the light diffusing portion 40 is absorbed at the wavelength control layer 41. Therefore, blur of a display does not occur and contrast is not degraded. However, if the quantity of light which is transmitted through the lateral surface 40c of the light diffusing portion 40 is increased, loss in the light quantity is generated and an image with high luminance cannot be obtained. Therefore, in the liquid crystal display device 1, it is preferable to use a backlight which emits light so that the light is not incident on the lateral surface 40c of the light diffusing portion 40 at an angle equal to or smaller than a critical angle, as it is called, a backlight having directivity.

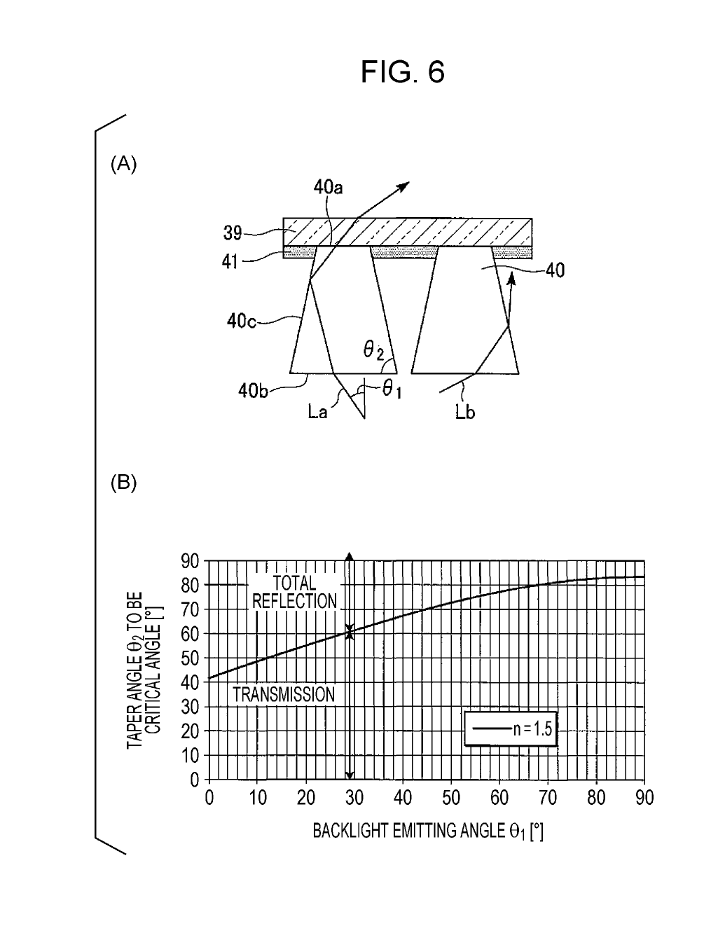

FIGS. 6(A) and (B) illustrate a relation between light emitted from the backlight and the lateral surface 40c of the light diffusing portion 40. As illustrated in FIG. 6(A), θ₁: an emitting angle from the backlight and θ₂: a taper angle of the light diffusing portion 40 are defined. Light La incident on the light diffusing portion 40 totally reflects at the lateral surface 40c to be emitted from the surface of the substrate 39 to the viewing side. At this time, light Lb an incident angle of which is large may not totally reflect at the lateral surface 40c and loss of incident light may be generated.

FIG. 6(B) illustrates a relation between an emitting angle θ₁ from the backlight and a taper angle θ₂ to be a critical angle. For example, when a refractive index of transparent resin which is a forming material of the light diffusing portion 40 is n=1.5 and the taper angle θ₂ of the light diffusing portion 40 is smaller than 60°, light of which the emitting angle θ₁ from the backlight is 30° does not totally reflect at the lateral surface 40c to be transmitted and light loss is generated. In order to make light the emitting angle θ₁ of which is within ±30° totally reflect at the lateral surface 40c without light loss, the taper angle of the light diffusing portion 40 is preferably equal to or larger than 60° and smaller than 90°.

The taper angle θ₂ of the lateral surface 40c of the light diffusing portion 40 is approximately 80°±5° as an example. In this embodiment, the taper angle θ₂ of the light diffusing portion 40 is set to 82°. In this embodiment, the taper angle θ₂ of the lateral surface 40c of the light diffusing portion 40 is fixed.

Here, the taper angle θ₂ of the lateral surface 40c of the light diffusing portion 40 is not limited to the above-mentioned range, but any angle is adopted as long as the angle allows incident light to be sufficiently diffused when the incident light is emitted from the light diffusing film 7. The taper angle θ₂ may successively vary from the light incident end surface 40b toward the light emitting end surface 40a.

The light scattering layer 50 is fixed on the other surface (the surface on the viewing side) of the substrate 39 with the adhesive layer 51 interposed, as illustrated in FIG. 1(B). The light scattering layer 50 is a film-shaped member in which a large number of light scattering bodies 52 such as acrylic beads are dispersed in binder resin such as photosensitive acrylic resin, for example. The thickness of the light scattering layer 50 is approximately 20 μm as an example. The spherical diameter of the light scattering body 52 having a spherical shape is approximately 0.5 to 20 μm as an example. The thickness of the adhesive layer 51 is approximately 25 μm as an example. The light scattering layer 50 has a function to scatter light diffused at the light diffusing portion 40 forward and further to extend the light toward a wide angle side.

In a case where a PET film having a birefringence is used as the substrate 39, a retardation is generated due to an influence of the birefringence. Therefore, iridescent unevenness is generated when an observer observes from the wide angle side and viewability is significantly degraded. Along with increase in luminance and in color purity of a liquid crystal display device in recent years, this type of iridescent unevenness is especially easily recognized visually. Therefore, the light scattering layer 50 exhibits a suppressing action with respect to visual recognition of iridescent unevenness. This action will be described later.

In this embodiment, a haze value of the light scattering layer 50 is set to 30 as an example. Here, the adhesive layer 51 does not have to be interposed between the light scattering layer 50 and the substrate 39. That is, the light scattering layer 50 may be directly formed on the other surface of the substrate 39.

Here, the light scattering body 52 is not limitedly composed of the above-mentioned substance, but may be composed of an arbitral transparent substance such as a resin piece made of acrylic polymer, olefin polymer, vinyl polymer, cellulose polymer, amide polymer, fluorine polymer, urethane polymer, silicon polymer, imide polymer, or the like, and a glass bead. Further, other than these transparent substances, a scattering body which does not absorb light and a reflector may be used. Alternatively, bubbles obtained by dispersing the light scattering bodies 52 in the light diffusing portion 40 may be employed. Individual light scattering body 52 can be formed to have various types of shapes such as a spherical shape, an oval spherical shape, a flat plate shape, and a polygonal cubic shape. Further, the light scattering bodies 52 may be formed to have even sizes or uneven sizes.

In the case of this embodiment, the light scattering layer 50 is disposed on an outermost surface of the light diffusing film 7, as illustrated in FIG. 3(A). Accordingly, light L which is orthogonally incident on the light incident end surface 40b of the light diffusing portion 40 is subjected to diffusion angle control in the light diffusing portion 40 and then, further scatters forward at the light scattering layer 50. Therefore, beams of light in various angles are emitted from the light scattering layer 50.

On the other hand, in a case of a light diffusing film 7X in which a light scattering layer is not disposed, light L which is orthogonally incident on a light incident end surface 40Xb of a light diffusing portion 40X is emitted in a manner to be concentrated on specific diffusion angles as illustrated in FIG. 3(B). As a result, light cannot be evenly scattered in a wide angle range and accordingly, a bright display is obtained only in a specific viewing angle.

Thus, in the case of this embodiment, the light scattering layer 50 is disposed on the outermost surface of the light diffusing film 7, so that diffusion angles of light can be prevented from concentrating on one angle. As a result, a light diffusing property of the light diffusing film 7 can be made further even and a bright display with a wide viewing angle can be obtained.

In this embodiment, the light diffusing film 7 is configured such that light which is incident from a surface 50f, which is on an opposite side to the light diffusing portion 40, of the light scattering layer 50 and is reflected at an interface between the substrate made of binder resin or the like and the light scattering body 52 or is refracted by the light scattering body 52 to be subjected to change of the traveling direction thereof is scattered forward. Such scattering condition can be satisfied by arbitrarily changing a particle diameter of the light scattering body 52 included in the light scattering layer 50, for example.

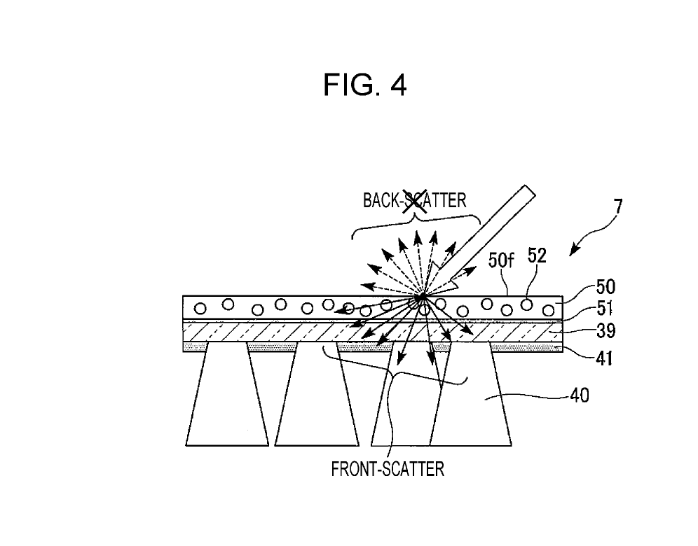

FIG. 4 is a sectional view illustrating the light diffusing film of this embodiment.

As illustrated in FIG. 4, in the case of this embodiment, the light scattering layer 50 is configured such that light which is incident from the upper surface 50f to the inside and is subjected to change of the traveling direction thereof by the light scattering body 52 is Mie-scattered on the upper surface 50f of the light scattering layer 50, in the light diffusing film 7. Therefore, so-called back-scatter does not occur. Accordingly, degradation in display quality and contrast caused by surface reflection can be suppressed.

That is, the light scattering layer 50 serves as an antiglare treatment layer (antiglare layer) as well. In the case of this embodiment, the light scattering layer 50 including a plurality of light scattering bodies 52 is formed on the surface on the viewing side of the substrate 39, so that the light scattering layer 50 serves also as an antiglare treatment layer functioning when a user looks at the liquid crystal display device. According to this configuration, it is not necessary to separately provide an antiglare treatment layer, so that simplification and reduction in thickness of the liquid crystal display device can be attained.

Here, the light scattering layer 50 may be produced such that sandblasting treatment, embossing treatment, or the like is performed with respect to a surface of the substrate 39 to form fine concavities and convexities on the surface of the substrate 39, other than the above-described configuration including the light scattering bodies 52.

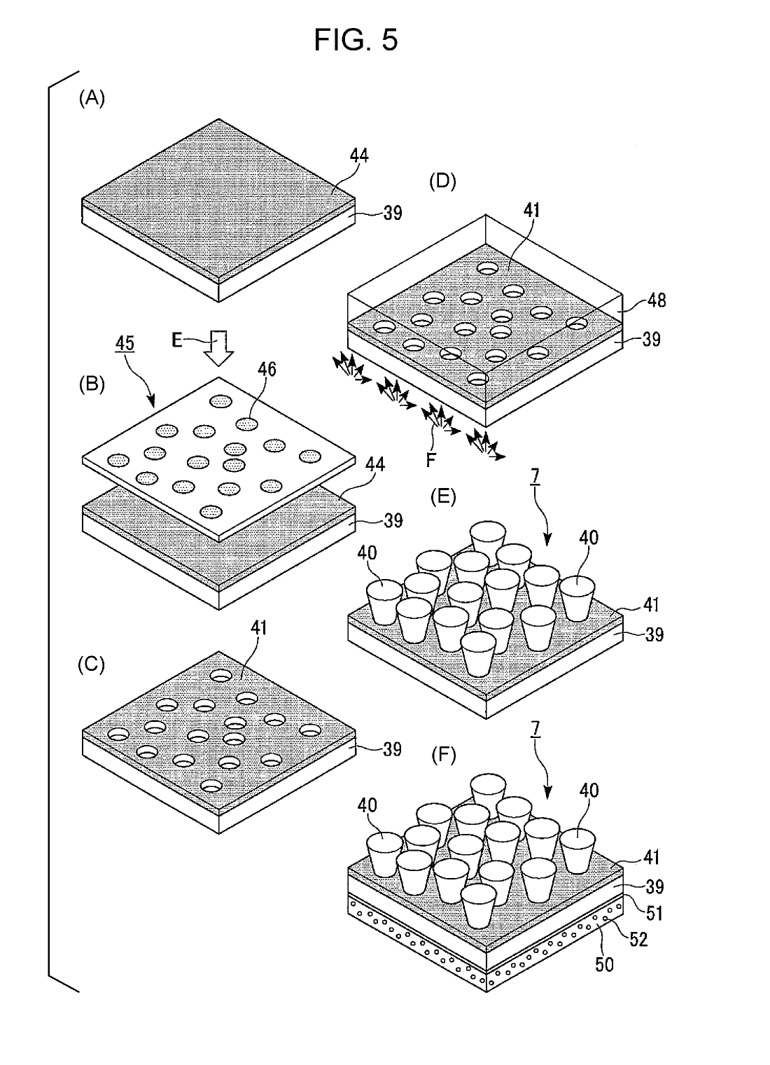

A method for manufacturing the liquid crystal display device 1 having the above-described configuration is now described with reference to FIG. 5.

The description will be given below while focusing on a manufacturing process of the light diffusing film 7.

An outline of a manufacturing process of the liquid crystal display body 6 is first described. The TFT substrate 9 and the color filter substrate 10 are first produced respectively. Then, the TFT substrate 9 and the color filter substrate 10 are positioned such that a surface, which is on a side on which the TFT 19 is formed, of the TFT substrate 9 and a surface, which is on a side on which the color filter 31 is formed, of the color filter substrate 10 are opposed to each other, and the TFT substrate 9 and the color filter substrate 10 are bonded with each other via a sealing member. After that, liquid crystal is injected into a space which is surrounded by the TFT substrate 9, the color filter substrate 10, and the sealing member. Then, the first polarizer 3 and the second polarizer 5 are respectively bonded to the both surfaces of the liquid crystal panel 4 which is thus produced, with an optical adhesive or the like. Through the above-described process, the liquid crystal display body 6 is completed.

Here, the conventionally-known method is used as methods for manufacturing the TFT substrate 9 and the color filter substrate 10, so that the description thereof is omitted.

First, as illustrated in FIG. 5(A), the substrate 39 which has a rectangular parallelepiped shape having 10 cm sides and 100 μm thickness and is made of polyethylene terephthalate is prepared and a black negative resist which contains carbon is applied on one surface of the substrate 39 as a material of the wavelength control layer by using a spin coating method so as to form a coating film 44 having the film thickness of 150 nm.

Subsequently, the substrate 39 on which the above-mentioned coating film 44 is formed is placed on a hot plate to perform prebake of the coating film at the temperature of 90° C. Accordingly, a solvent in the black negative resist is volatilized.

Subsequently, exposure is performed such that the coating film 44 is irradiated with light E via a photomask 45, on which a plurality of light shielding patterns 46 are formed, by using an exposure apparatus as illustrated in FIG. 5(B). At this time, an exposure apparatus which uses a combined beam of an i beam having the wavelength of 365 nm, an h beam having the wavelength of 404 nm, and a g beam having the wavelength of 436 nm is used. The exposure amount is set to 100 mJ/cm². In the case of this embodiment, exposure of a transparent negative resist is performed by using the wavelength control layer 41 as a mask in the following step to form the light diffusing portions 40, so that positions of the light shielding patterns 46 of the photomask 45 correspond to forming positions of the light diffusing portions 40. All of a plurality of light shielding patterns 46 are circular patterns a diameter of which is 20 μm and are arranged at random. Therefore, though intervals (pitches) between adjacent light shielding patterns 46 are not even, an average interval obtained by averaging intervals among a plurality of light shielding patterns 46 is 25 μm.

It is preferable that an average interval among the light shielding patterns 46 is smaller than an interval (pitch) of pixels of the liquid crystal panel 4. Accordingly, at least one light diffusing portion 40 is formed within a pixel. Therefore, the viewing angle can be widened when the light diffusing film 7 is combined with a liquid crystal panel which has a small pixel pitch and is used in mobile equipment and the like, for example.

After the exposure is performed by using the above-mentioned photomask 45, the coating film 44 which is composed of the black negative resist is developed by using a special developing solution and is dried at 100° C. and thus, the wavelength control layer 41 which has a plurality of circular opening portions is formed on one surface of the substrate 39 as illustrated in FIG. 5(C). The circular opening portions correspond to the forming regions of the light diffusing portions 40 in the following step.

Here, the wavelength control layer 41 is formed by the photolithographic method using the black negative resist in this embodiment, but instead of this configuration, a positive resist can be used if a photomask in which the light shielding patterns 46 of this embodiment and a light transmitting portion are inverted is used. Alternatively, the wavelength control layer 41 which is patterned may be directly formed by using a vapor deposition method, a printing method, an ink jet method, or the like.

Subsequently, as illustrated in FIG. 5(D), a transparent negative resist which is made of acrylic resin is applied on the upper surface of the wavelength control layer 41 as a material of the light diffusing portions by using the spin coating method to form a coating film 48 the film thickness of which is 25 μm. Then, the substrate 39 on which the above-mentioned coating film 48 is formed is placed on a hot plate and prebake of the coating film 48 is performed at the temperature of 95° C. Accordingly, a solvent in the transparent negative resist is volatilized.

Subsequently, exposure is performed such that the coating film 48 is irradiated with diffused light F from the substrate 39 side by using the wavelength control layer 41 as a mask. At this time, an exposure apparatus which uses a combined beam of an i beam having the wavelength of 365 nm, an h beam having the wavelength of 404 nm, and a g beam having the wavelength of 436 nm is used. The exposure amount is set to 600 mJ/cm². Parallel light or diffused light is used in the exposure step. As a means for changing parallel light which is emitted from the exposure apparatus into the diffused light F to be radiated to the substrate 39, a diffusing plate a haze of which is approximately 50 may be disposed on a light path of light emitted from the exposure apparatus. Through the exposure performed with the diffused light F, the coating film 48 is radially exposed from the opening portions in the wavelength control layer 41 and accordingly, reverse-tapered lateral surfaces of the light diffusing portions 40 are formed.

After that, the substrate 39 on which the above-mentioned coating film 48 is formed is placed on a hot plate and post exposure bake (PEB) of the coating film 48 is performed at the temperature of 95° C.

Subsequently, the coating film 48 which is composed of the transparent negative resist is developed with a special developing solution and post bake is performed at 100° C. so as to form a plurality of light diffusing portions 40 on one surface of the substrate 39 as illustrated in FIG. 5(E).

Then, as illustrated in FIG. 5(F), the light scattering layer 50 which is configured such that a large number of light scattering bodies 52 composed of acrylic beads or the like are dispersed in binder resin such as acrylic resin is bonded on the other surface of the substrate 39 with the adhesive layer 51 interposed.

Through the above-described process, the light diffusing film 7 according to this embodiment is completed.

Here, a liquid resist is applied in the formation of the wavelength control layer 41 and the light diffusing portions 40 in the above-described example, but instead of this configuration, a film resist may be bonded on one surface of the substrate 39.

Finally, the light diffusing film 7 which is completed is bonded on the liquid crystal display body 6 with an optical adhesive or the like in a state in which the substrate 39 faces the viewing side and the light diffusing portions 40 are opposed to the second polarizer 5 as illustrated in FIGS. 1(A) and (B).

Through the above-described process, the liquid crystal display device 1 according to this embodiment is completed.

Here, a reason why iridescent unevenness is generated in a case where the substrate 39 has a birefringence is described. In general, when a substrate having a birefringence is interposed between two polarizers, the intensity of light emitted from the polarizer on an emitting side varies depending on a wavelength of incident light. Light which is converted into linearly polarized light, which vibrates in a specific direction, by the first (an incident side) polarizer is divided into an ordinary beam and an extraordinary beam by the birefringence substrate. Here, traveling speeds in the inside of the substrate are different from each other between the ordinary beam and the extraordinary beam, so that a retardation is generated. The vibration direction of light which is incident on a second polarizer varies depending on a retardation with respect to a wavelength. As a result, a ratio of components of light which is transmitted through the second polarizer varies for every wavelength. Accordingly, a color of emitted light varies depending on an observation angle and thus, iridescent unevenness is generated.

From the above-mentioned principle of generation of iridescent unevenness, in a case where light emitted from a birefringence substrate is observed, it is seemed that the intensity of the emitted light does not vary and iridescent unevenness is not generated because the birefringence substrate is not interposed between polarizers. However, an emitting end surface of the birefringence substrate functions equivalently to a polarizer, iridescent unevenness is generated depending on an angle observing the birefringence substrate. Detailed description is provided below.

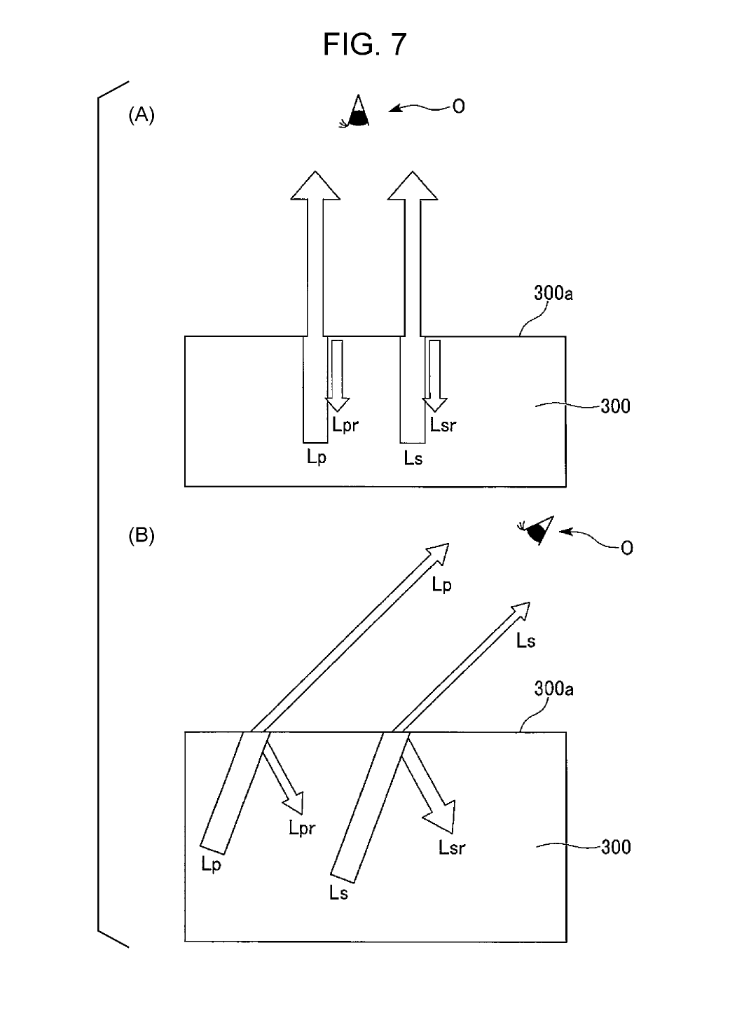

FIGS. 7(A) and (B) illustrate a mechanism of an occurrence of iridescent unevenness. FIG. 7(A) illustrates a case in which a birefringence substrate 300 is viewed from the front, and FIG. 7(B) illustrates a case in which the birefringence substrate 300 is viewed from the oblique direction. FIGS. 7(A) and (B) illustrate a state that light which is divided into P polarized light Lp and S polarized light Ls by the birefringence substrate 300 is visually recognized by an observer O. Here, FIGS. 7(A) and (B) illustrate a case where the intensity of the P polarized light Lp and the intensity of the S polarized light Ls are same as each other.

As illustrated in FIG. 7(A), in a case where the observer O observes the birefringence substrate 300 from the front, light which is emitted in an orthogonal direction from an emitting end surface 300a is incident on eyes of the observer O. That is, the P polarized light Lp and the S polarized light Ls which travel in the inside of the birefringence substrate 300 in a direction orthogonal to the emitting end surface 300a are emitted from the emitting end surface 300a. The P polarized light Lp and the S polarized light Ls which are orthogonally incident on the emitting end surface 300a mutually have the same reflectance at the emitting end surface 300a. Therefore, the intensities of the P polarized light Lp and the S polarized light Ls which are incident on eyes of the observer O are same as each other. Accordingly, light emitted from the birefringence substrate 300 does not exhibit iridescent unevenness at the emitting end surface 300a.

On the other hand, as illustrated in FIG. 7(B), in a case where the observer O observes the birefringence substrate 300 from the oblique direction, light which is obliquely emitted from the emitting end surface 300a is incident on eyes of the observer O. Both of the P polarized light Lp and the S polarized light Ls which obliquely travel in the inside of the birefringence substrate 300 are reflected and refracted at the emitting end surface 300a.

Here, it is generally known that P polarized light and S polarized light depend on an incident angle with respect to a boundary surface to have different reflectances from each other. In more detail, the reflectance of S polarized light is larger than the reflectance of P polarized light. Therefore, between the P polarized light Lp and the S polarized light Ls, the intensities of reflected light which is reflected at the emitting end surface 300a are different from each other. For example, as illustrated in FIG. 7(B), the intensity of reflected light Lsr of the S polarized light Ls is larger than the intensity of reflected light Lpr of the P polarized light Lp. Accordingly, between the P polarized light Lp and the S polarized light Ls which are refracted at the emitting end surface 300a and are incident on eyes of the observer O, the intensity of the P polarized light Lp is larger. In other words, in a case where the birefringence substrate 300 is obliquely viewed, the emitting end surface 300a serves as a polarization layer as a result. Accordingly, iridescent unevenness is generated. Iridescent unevenness is more easily generated when an in-plane retardation of a substrate is in a range from 500 nm to 10000 nm and especially, iridescent unevenness is visually observed when the in-plane retardation of the substrate is in a range from 1000 nm to 4000 nm.

The inventors carried out simulation of the intensity of emitted light in a case where light which is transmitted through the second polarizer of a liquid crystal panel is transmitted through a substrate (a PET film) which has a birefringence.

Simulation conditions were set such that the polarization degree of the second polarizer was 100%, an in-plane retardation of the substrate (Δnd) was 1.00 μm, the polarization degree of the substrate was 50%, and the wavelength dispersion of the substrate (450 nm/590 nm) was 1.10. An absorption axis of the second polarizer and a slow axis of the substrate were set to be parallel to each other.

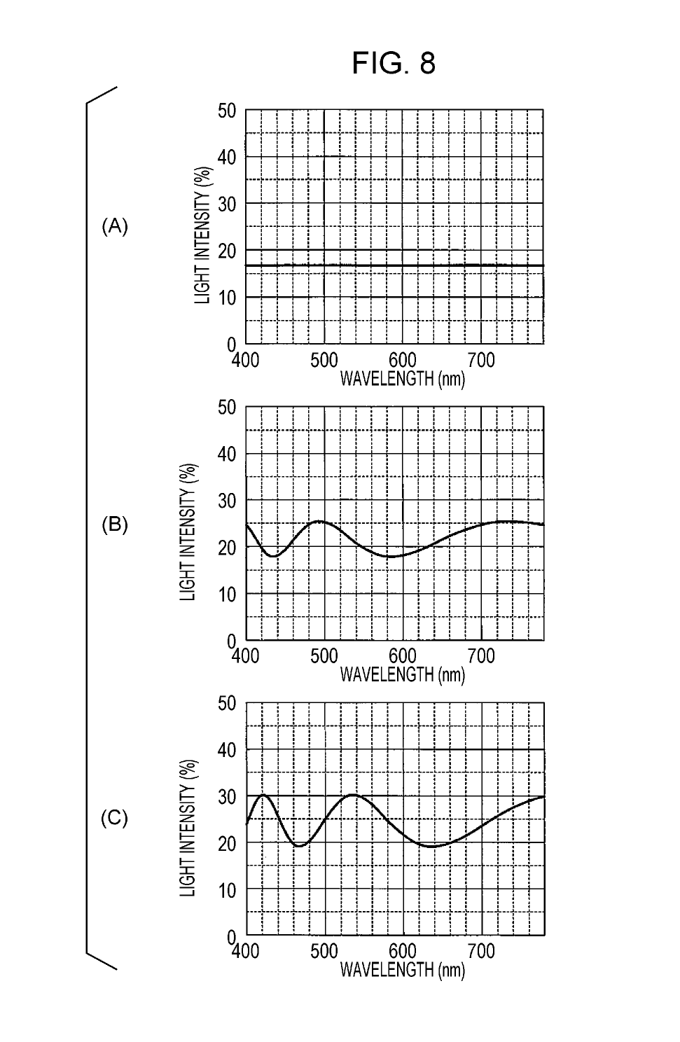

FIGS. 8(A) to (C) are graphs illustrating simulation results of the intensity of emitted light from the birefringence substrate. FIG. 8(A) illustrates the intensity of light emitted in a direction of an azimuth angle of 45° and a polar angle of 0°. FIG. 8(B) illustrates the intensity of light emitted in a direction of an azimuth angle of 45° and a polar angle of 60°. FIG. 8(C) illustrates the intensity of light emitted in a direction of an azimuth angle of 45° and a polar angle of 80°. The intensity of light emitted in the direction of the polar angle of θ° corresponds to the intensity of light when an observer observes the liquid crystal display device from a direction of the polar angle of θ°. The horizontal axis of FIGS. 8(A) to (C) represent a wavelength (nm) of light and the vertical axis of FIGS. 8(A) to (C) represent the relative intensity (%) of transmitted light. The intensity of light of a case where the light incident on the second polarizer was transmitted through air was set to 100%.

As illustrated in FIG. 8(A), in a case where the observer observes the liquid crystal display device from the front direction (the direction of the polar angle of 0°), the intensity of light does not vary in each wavelength because S polarized light and P polarized light have no difference in reflectance thereof at an interface between the birefringence substrate and air. On the other hand, as illustrated in FIGS. 8(B) and (C), in a case where the observer observes the liquid crystal display device from the oblique direction (the directions of the polar angles of 60° and 80°), peaks and valleys are generated in the light intensity curve depending on a wavelength because S polarized light and P polarized light have a difference in reflectance thereof at the interface between the birefringence substrate and air.

As illustrated in FIG. 8(B), in the case of the polar angle of 60°, there are peaks in a green color region (around the wavelength of 490 nm) and a red color region (around the wavelength of 700 nm), so that yellow color light is visually recognized. As illustrated in FIG. 8(C), in the case of the polar angle of 80°, there are peaks in a blue color region (around the wavelength of 420 nm) and a green color region (around the wavelength of 540 nm), so that blue-green color light is visually recognized. Thus, the observer visually recognizes light of different colors depending on an observation angle, so that the observer recognizes iridescence unevenness.

Thus, there has been such defect that in a case where the substrate 39 of the light diffusing film 7 has a birefringence, an advantageous effect in which distribution of light diffusion angles is widen toward a wide angle is obtained while iridescence unevenness is visually recognized merely by disposing the light diffusing film 7. On the other hand, according to the liquid crystal display device 1 of this embodiment, light which is transmitted through the light diffusing film 7 is scattered by the light scattering layer 50 and consequently, beams of light of different colors are mixed. Thus, color mixture of light is generated, so that iridescent unevenness can be suppressed.

### Second Embodiment

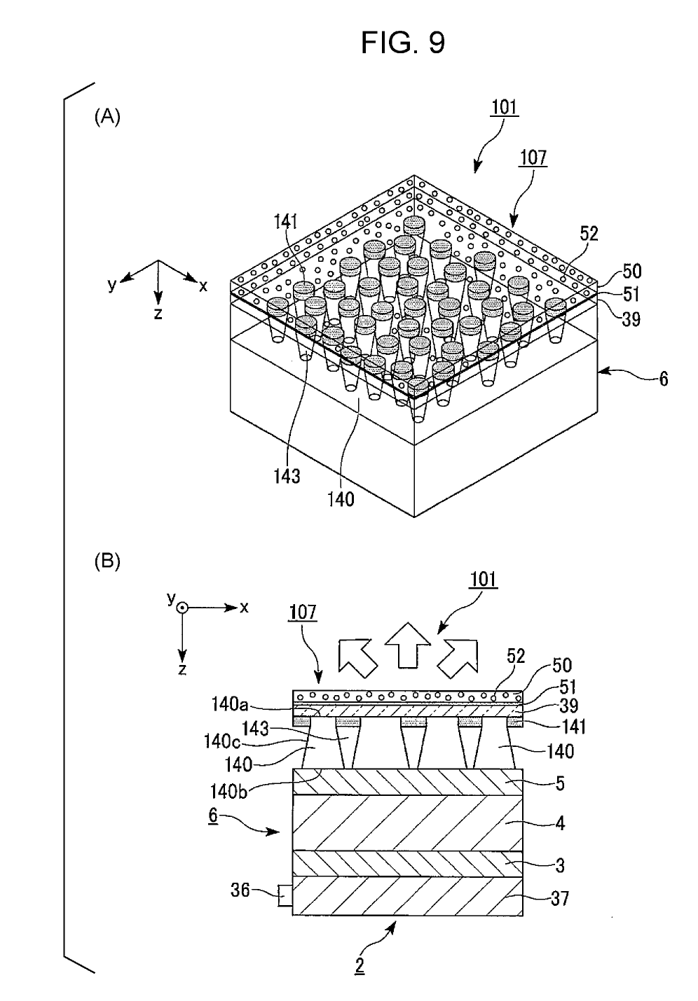

A second embodiment of the present invention is described below with reference to FIGS. 9 to 13.

The basic configuration of a liquid crystal display device of this embodiment is identical to that of the first embodiment and merely the configurations of a light diffusing portion and a wavelength control layer of a light diffusing film are different from those of the first embodiment. Accordingly, the description of the basic configuration of the liquid crystal display device is omitted and only a description of the light diffusing film is provided in this embodiment.

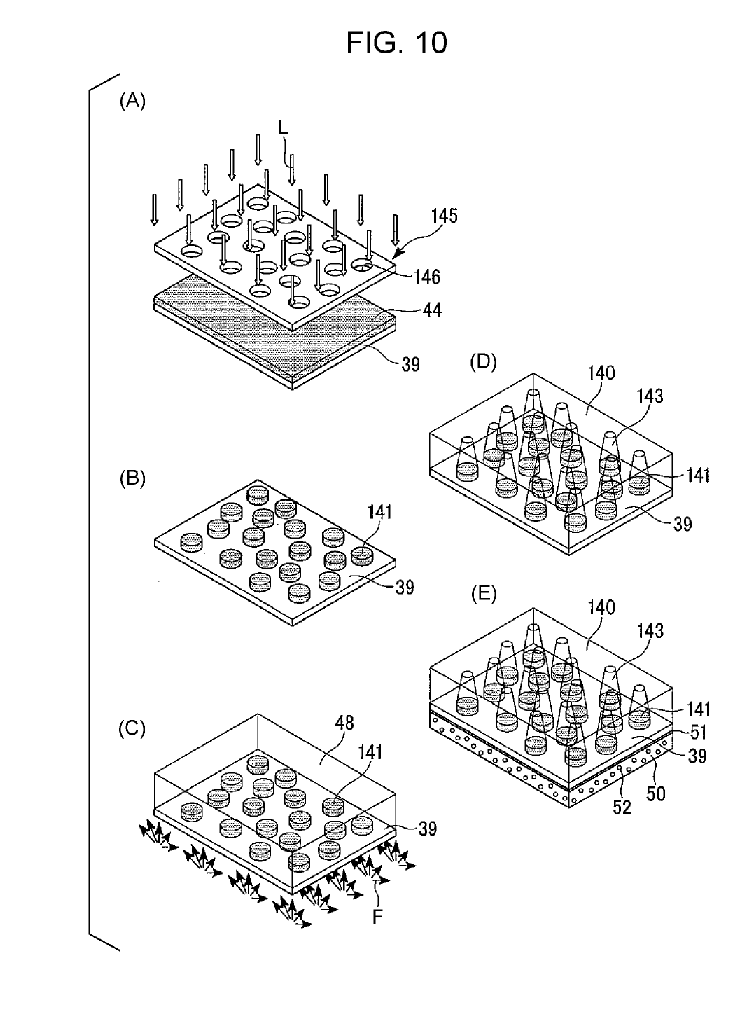

FIGS. 9(A) and (B) are schematic views illustrating a liquid crystal display device 101 according to the second embodiment. FIG. 9(A) is a perspective view illustrating the liquid crystal display device 101 of the second embodiment. FIG. 9(B) is a sectional view illustrating the liquid crystal display device 101 of the second embodiment. FIGS. 10(A) to (E) are perspective views illustrating a light diffusing film while following the order of a manufacturing process.

In FIGS. 9(A) and (B) and FIGS. 10(A) to (E), constituent elements common to those in the drawings which are used in the first embodiment are given identical reference characters and detailed descriptions thereof are omitted.

In the first embodiment, a plurality of light diffusing portions 40 which are formed on one surface of the substrate 39 and the wavelength control layer 41 which is formed in a region other than the forming regions of the light diffusing portions 40 on one surface of the substrate 39 are provided, a plurality of light diffusing portions 40 are arranged in a dotted manner when viewed from a normal line direction on one surface of the substrate 39, and the wavelength control layer 41 is continuously formed on the region other than the forming regions of the light diffusing portions 40. On the other hand, a light diffusing film 107 of the second embodiment includes a plurality of wavelength control layers 141 which are formed on one surface of the substrate 39 and a light diffusing portion 140 which is formed in a region other than the forming regions of the wavelength control layers 141 in one surface of the substrate 39. A plurality of wavelength control layers 141 are arranged in a dotted manner when viewed from a normal line direction on one surface of the substrate 39. The light diffusing portion 140 is continuously formed on the region other than the forming regions of the wavelength control layers 141.

A plurality of wavelength control layers 141 are arranged in a manner to be dotted at random (aperiodically) on the substrate 39. Accordingly, a plurality of air-cavities 143 which are formed on identical positions of a plurality of wavelength control layers 141 are also arranged on the substrate 39 at random.

In this embodiment, each of the wavelength control layers 141 has a circular planar shape when viewed from the normal line direction of the substrate 39. A diameter of each of the wavelength control layers 141 is 10 μm, for example. All of a plurality of wavelength control layers 141 have the diameters identical to each other. A plurality of wavelength control layers 141 are formed on the substrate 39 in a dotted manner, and accordingly, the light diffusing portion 140 of this embodiment is continuously formed on the substrate 39 in a wall shape.

In the forming region of the wavelength control layer 141 in the light diffusing film 107, the air-cavity 143 of which a cross-sectional area of a cross section which is parallel to one surface of the substrate 39 is larger on the wavelength control layer 141 side and is gradually decreased as separating from the wavelength control layer 141 is formed. The air-cavity 143 has a so-called forward-tapered approximately circular truncated cone shape when viewed from the substrate 39 side. Air exists in the inside of the air-cavity 143. A portion other than the air-cavities 143 of the light diffusing film 107, that is, a portion in which the light diffusing portion 140 continuously exists contributes to transmission of light. Light incident on the light diffusing portion 140 is guided in a state in which the light is approximately sealed in the inside of the light diffusing portion 140 while totally reflecting on an interface between the light diffusing portion 140 and the air-cavity 143, and is emitted to the outside via the substrate 39.

In the case of this embodiment, air exists in the air-cavity 143, so that if the light diffusing portion 140 is made of transparent resin, for example, a lateral surface 140c of the light diffusing portion 140 is an interface between the transparent resin and air. Here, the refractive index difference on an interface between the inside and the outside of the light diffusing portion 140 is larger in a case where the air-cavity 143 is filled with air than a case where the periphery of the light diffusing portion 140 is filled with other general materials having a low refractive index. Therefore, an incident angle range in which light totally reflects on the lateral surface 140c of the light diffusing portion 140 is wide based on the Snell's law. As a result, loss of light is further suppressed and high luminance can be obtained.

Instead of air, the air-cavity 143 may be filled with inactive gas such as nitrogen. Alternatively, the inside of the air-cavity 143 may be in a vacuumed state.

In a similar manner to the first embodiment, the light scattering layer 50 is formed on a surface opposite to a surface, on which the light diffusing portion 140 is formed, of the substrate 39.

Next, a method for manufacturing the liquid crystal display device 101 having the above-described configuration is described with reference to FIGS. 10(A) to (E).

The description will be given below while focusing on a manufacturing process of the light diffusing film 107.

First, as illustrated in FIG. 10(A), the substrate 39 which has a rectangular parallelepiped shape having 10 cm sides and 100 μm thickness and is composed of a PET film is prepared and a black negative resist which contains carbon is applied on one surface of the substrate 39 as a material of the wavelength control layers by using a spin coating method so as to form a coating film 44 having the film thickness of 150 nm.

Subsequently, the substrate 39 on which the above-mentioned coating film 44 is formed is placed on a hot plate to perform prebake of the coating film at the temperature of 90° C. Accordingly, a solvent in the black negative resist is volatilized.

Subsequently, exposure is performed such that the coating film 44 is irradiated with light L via a photomask 145, on which a plurality of opening patterns 146 having a circular planar shape are formed, by using an exposure apparatus. At this time, an exposure apparatus which uses a combined beam of an i beam having the wavelength of 365 nm, an h beam having the wavelength of 404 nm, and a g beam having the wavelength of 436 nm is used. The exposure amount is set to 100 mJ/cm².

As illustrated in FIG. 10(A), the photomask 145 which is used in forming the wavelength control layers 141 has a plurality of circular opening patterns 146 which are arranged at random. When this photomask 145 is designed, the opening patterns 146 are regularly arranged with a constant pitch at first. Then, fluctuation is generated in reference positional data of each of the opening patterns 146 such as a center point of the opening patterns 146 by using a random function so as to make variations of positions of the opening patterns 146. Thus, the photomask 145 which has a plurality of opening patterns 146 which are arranged at random can be produced.

After the exposure is performed by using the above-mentioned photomask 145, the coating film 44 which is composed of the black negative resist is developed by using a special developing solution and is dried at 100° C. Accordingly, a plurality of wavelength control layers 141 which have a circular planar shape are formed on one surface of the substrate 39 as illustrated in FIG. 10(B). In the case of this embodiment, exposure of the transparent negative resist is performed by using the wavelength control layers 141, which are composed of black negative resists, as a mask so as to form the air-cavities 143 in the following step. Therefore, positions of the opening patterns 146 of the photomask 145 correspond to forming positions of the air-cavities 143. The wavelength control layers 141 having a circular shape correspond to non-forming regions (the air-cavities 143) of the light diffusing portion 140 in the following step. All of a plurality of opening patterns 146 are circular patterns which have diameters of 10 μm.

The wavelength control layers 141 are formed by the photolithographic method using the black negative resist in this embodiment, but instead of this configuration, a positive resist having a light absorption property can be used if a photomask in which the opening patterns 146 of this embodiment and a light shielding pattern are inverted is used. Alternatively, the wavelength control layers 141 which are patterned may be directly formed by using a vapor deposition method, a printing method, or the like.

Subsequently, as illustrated in FIG. 10(C), a transparent negative resist which is made of acrylic resin is applied on upper surfaces of the wavelength control layers 141 as a material of the light transmitting portion by using the spin coating method to form the coating film 48 the film thickness of which is 25 μm. Then, the substrate 39 on which the above-mentioned coating film 48 is formed is placed on a hot plate and prebake of the coating film 48 is performed at the temperature of 95° C. Accordingly, a solvent in the transparent negative resist is volatilized.

Subsequently, exposure is performed such that the coating film 48 is irradiated with diffused light F from the substrate 39 side by using the wavelength control layers 141 as a mask. At this time, an exposure apparatus which uses a combined beam of an i beam having the wavelength of 365 nm, an h beam having the wavelength of 404 nm, and a g beam having the wavelength of 436 nm is used. The exposure amount is set to 600 mJ/cm². Diffused light is used in the exposure step. As a means for changing parallel light which is emitted from the exposure apparatus into the diffused light F to be radiated to the substrate 39, a diffusing plate a haze of which is approximately 50 is disposed on a light path of light emitted from the exposure apparatus. Through the exposure performed with the diffused light F, the coating film 48 is radially exposed from edges of the wavelength control layers 141 toward the inside of the wavelength control layers 141. Accordingly, the air-cavities 143 having a forward-tapered shape are formed and lateral surfaces having a reverse-tapered shape are formed on portions, which face the air-cavities 143, of the light diffusing portion 140.

After that, the substrate 39 on which the above-mentioned coating film 48 is formed is placed on a hot plate and post exposure bake (PEB) of the coating film 48 is performed at the temperature of 95° C.

Subsequently, the coating film 48 which is composed of the transparent negative resist is developed with a special developing solution and post bake is performed at 100° C. so as to form the light diffusing portion 140 which includes a plurality of air-cavities 143 on one surface of the substrate 39 as illustrated in FIG. 10(D).

Then, as illustrated in FIG. 10(E), the light scattering layer 50 which is configured such that a large number of light scattering bodies 52 composed of acrylic beads or the like are dispersed in binder resin such as acrylic resin is bonded on the other surface of the substrate 39 with the adhesive layer 51 interposed.

Through the above-described process, the light diffusing film 107 according to this embodiment is completed.

A total light transmittance of the light diffusing film 107 is preferably 90% or more. When the total light transmittance is 90% or more, sufficient transparency can be obtained and optical performance required for the light diffusing film 107 can be sufficiently exerted. A total light transmittance is based on the regulation of JIS K7361-1.

Here, a liquid resist is applied in the formation of the wavelength control layers 141 and the light diffusing portion 140 in the above-described example, but instead of this configuration, a film resist may be bonded on one surface of the substrate 39.

Finally, the light diffusing film 107 which is completed is bonded on the liquid crystal display body 6 with an optical adhesive or the like in a state in which the substrate 39 faces the viewing side and the light diffusing portion 140 is opposed to the second polarizer 5 as illustrated in FIG. 9(B).

Through the above-described process, the liquid crystal display device 101 according to this embodiment is completed.

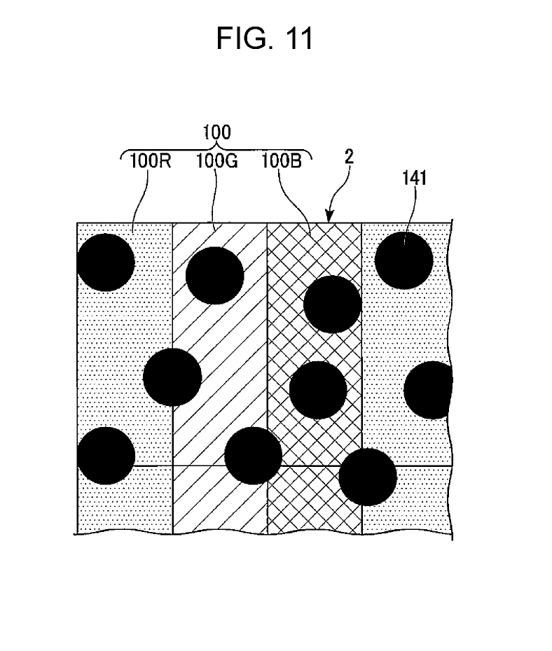

FIG. 11 illustrates a disposition relation between a pixel 100 of the liquid crystal panel 4 and the wavelength control layer 141. As illustrated in FIG. 11, when the pixel 100 of the liquid crystal panel 4 and the wavelength control layer 141 are viewed in a plane, it is preferable that at least one of parts of the wavelength control layers 141 is positioned on a portion corresponding to one dot of the liquid crystal panel 4. In this case, one pixel 100 of the liquid crystal panel 4 is composed of three dots 100R, 1006, and 100B of red (R), green (G), and blue (B). Thus, at least one of the wavelength control layers 141 is formed within one pixel 100, so that emission can be performed with respect to an observer side in a state that information of one dot 100R, 100G, or 100B is securely extended.

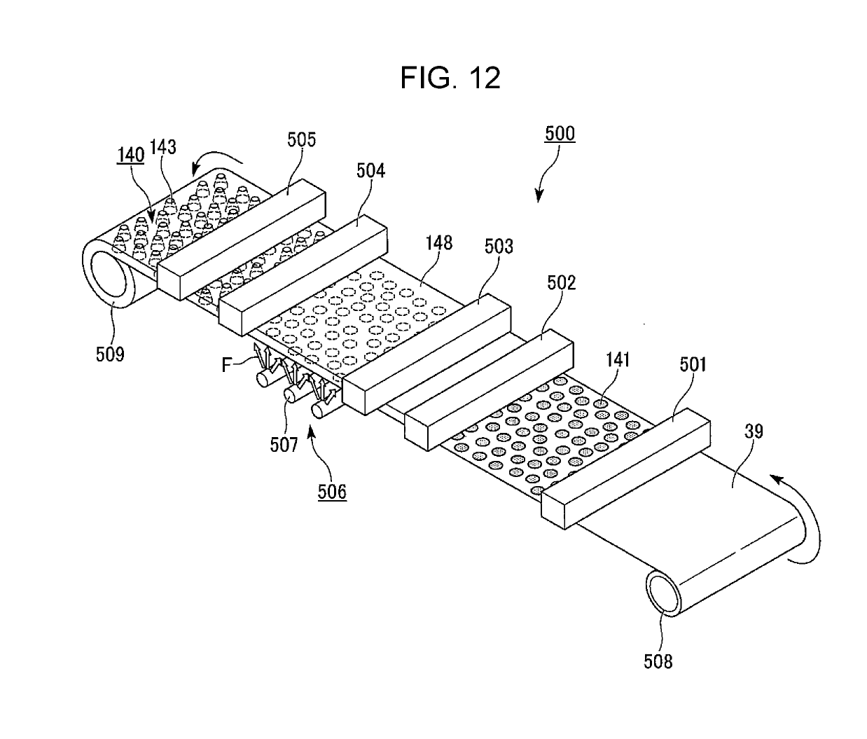

FIG. 12 is a schematic configuration diagram illustrating an example of a manufacturing device for manufacturing the light diffusing film 107.

A manufacturing device 500 illustrated in FIG. 12 conveys the long substrate 39 by roll to roll and consistently performs various types of processing during the conveyance. The manufacturing device 500 forms the wavelength control layers 141 by using a printing method instead of the above-described photolithographic method using the photomask 145.

The manufacturing device 500 is configured such that a feed roller 508 which feeds the substrate 39 is provided on one end, a winding roller 509 which winds the substrate 39 is provided on the other end, and the substrate 39 is conveyed from the feed roller 508 side toward the winding roller 509 side.

Above the substrate 39, a printing device 501, a first drying device 502, a coating device 503, a developing device 504, and a second drying device 505 are disposed in sequence from the feed roller 508 side toward the winding roller 509 side (along a conveying direction of the substrate 39).

Further, in a region between the coating device 503 and the developing device 504 and below the substrate 39, an exposure device 506 is disposed.

The printing device 501 prints the wavelength control layers 141 on the substrate 39. The first drying device 502 dries the wavelength control layers 141 formed by the printing. The coating device 503 applies a transparent negative resist on the wavelength control layers 141 to form the coating film 148. The developing device 504 develops the transparent negative resist after exposure with a developing solution so as to form the air-cavities 143. The second drying device 505 dries the substrate 39 on which the light diffusing portion 140 which is composed of the transparent resist after developing is formed. After that, the substrate 39 on which the light diffusing portion 140 is formed may further be bonded with the second polarizer 5 to be integrated.

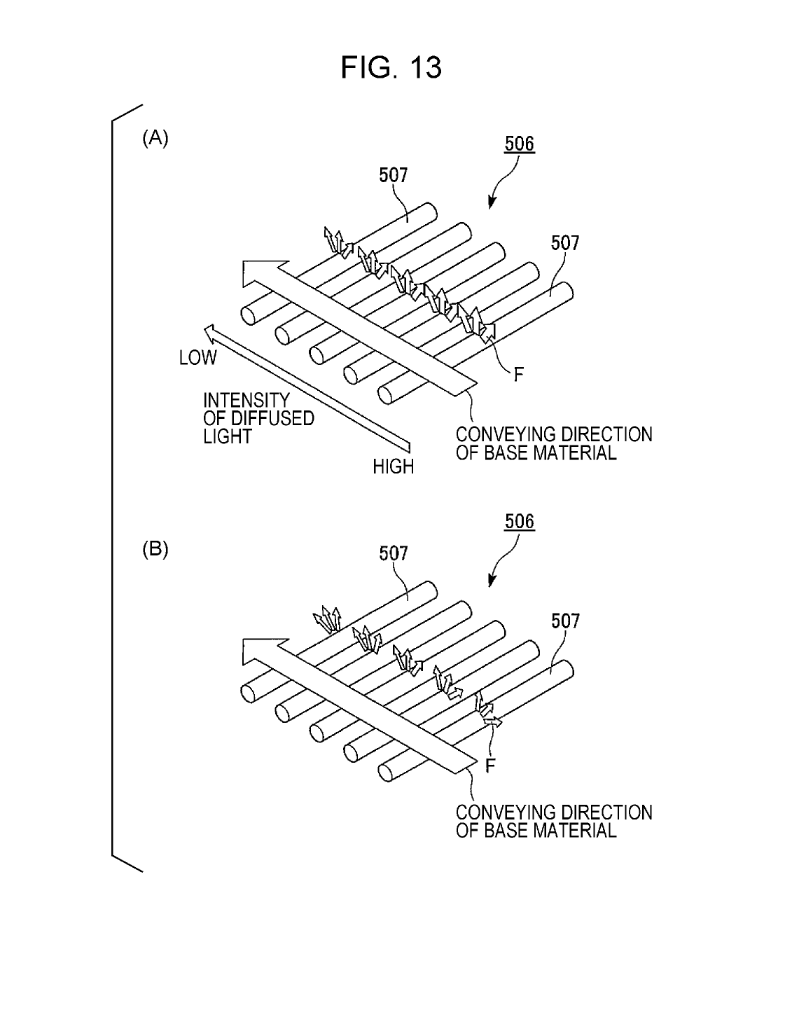

The exposure device 506 performs exposure of the coating film 148 composed of the transparent negative resist from the substrate 39 side. FIGS. 13(A) and (B) are drawings illustrating the exposure device 506 only taken from the manufacturing device 500.

As illustrated in FIG. 13(A), the exposure device 506 is provided with a plurality of light sources 507. The intensity of light F may be changed such that the intensities of the light F emitted from respective light sources 507 are gradually lowered along with the conveyance of the substrate 39, for example. Alternatively, as illustrated in FIG. 13(B), in the exposure device 506, emitting angles of exposure light F emitted from respective light sources 507 may be gradually changed along with the conveyance of the substrate 39. In FIG. 13(B), the emitting angle of the exposure light F is changed such that a light beam axis (a central axis of a light beam flux of diffused light) of the exposure light F which is diffused light is gradually inclined to the conveying direction of the substrate 39 along the conveying direction of the substrate 39. By using the exposure device 506, an inclination angle of the lateral surface 140c of the light diffusing portion 140 can be controlled to be a desired angle. Further, diffused light may be generated by combining exposure light which is parallel light with a diffusing plate.

When the substrate 39 on which the light diffusing portion 140 is formed by using the manufacturing device 500 (a raw fabric) is bonded to the liquid crystal panel 4, the raw fabric is arbitrarily cut to a size of the liquid crystal panel 4 so as to manufacture the light diffusing film 107. In cutting out the raw fabric, the raw fabric is cut at a portion including the wavelength control layers 141 at a high probability (practically with substantial certainty) because the wavelength control layers 141 are formed at random in the raw fabric. Accordingly, in a light diffusing film which is obtained by cutting the raw fabric, the air-cavities 143 which are overlapped with the wavelength control layers 141 are formed to be brought into contact with a circumferential portion of the substrate 39.

In the liquid crystal display device 101 of the second embodiment as well, such advantageous effect, which is similar to that of the first embodiment, can be obtained that light which is transmitted through the light diffusing film 107 is scattered by the light scattering layer 50, then beams of light of different colors are mixed, and as a result, iridescent unevenness can be suppressed.

Especially, according to the configuration of the second embodiment, a plurality of air-cavities 143 which are provided to the light diffusing film 107 are separated from each other and a portion to be the light diffusing portion 140 has a shape continuing in a plane. Accordingly, even if concentration of the air-cavities 143 is raised and the volume of the light diffusing portion 140 is reduced so as to raise a level of diffusion of light, for example, a contact area between the light diffusing portion 140 and the substrate 39 can be sufficiently secured. Therefore, adhesion between the light diffusing portion 140 and the substrate 39 is high. Accordingly, a defect, which is caused by an external force or the like, of the light diffusing portion 140 is hardly generated and a desired light diffusing function can be exerted.

The transparent resin layer is irradiated with the light F from the back face side of the substrate 39 by using the wavelength control layers 141 as a mask, so that the light diffusing portion 140 is formed in a non-forming region of the wavelength control layers 141 in a state in which the light diffusing portion 140 is self-matched (self-aligned). As a result, the light diffusing portion 140 and the wavelength control layers 141 are not overlapped with each other and light transmittance can be securely maintained. Further, a precise alignment operation is not required, so that time required for manufacturing can be shortened.

According to this configuration, volumes of respective air-cavities 143 are identical to each other, so that a volume of resin which is removed in development of the transparent resin layer is constant. Therefore, a developing speed of respective air-cavities 143 is constant in a step of forming respective air-cavities 143 and a desired taper shape can be formed. As a result, uniformity of fine shapes of the light diffusing film 107 is enhanced and a yield is enhanced.

### Third Embodiment

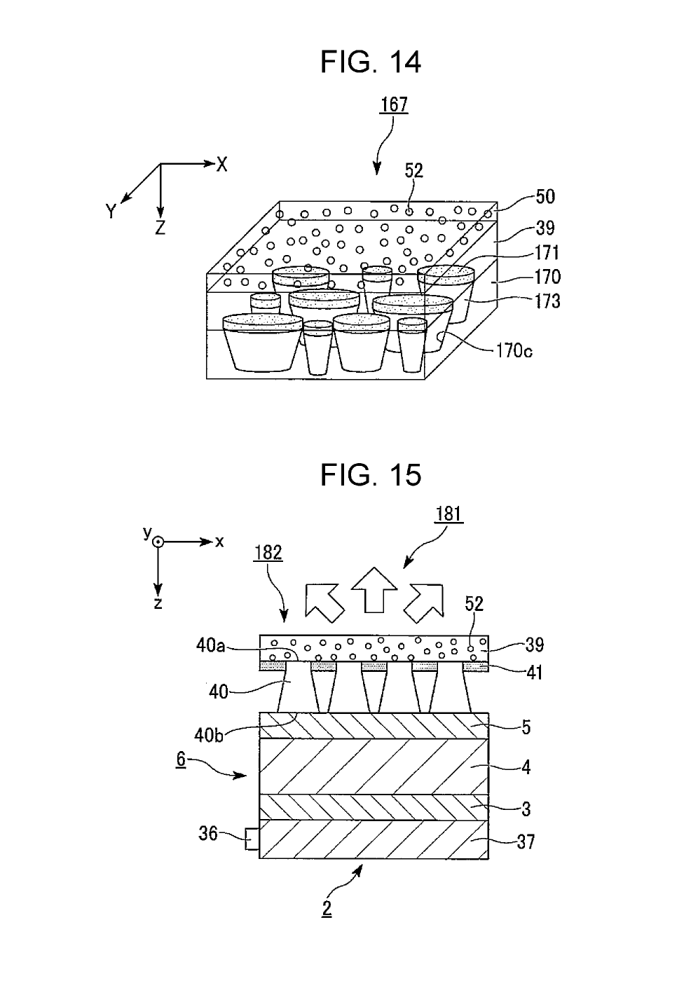

A third embodiment of the present invention is described below with reference to FIG. 14.

The basic configuration of a liquid crystal display device of this embodiment is identical to that of the first embodiment, but the configuration of a light control film is different from that of the first embodiment.

Accordingly, the description of the basic configuration of the liquid crystal display device is omitted and a description of the light control film is provided in this embodiment.

FIG. 14 is a perspective view illustrating the light diffusing film according to the third embodiment.

In FIG. 14, constituent elements common to those in the drawings which are used in the first embodiment are given identical reference characters and detailed descriptions thereof are omitted.

A light diffusing film 167 of the third embodiment includes the substrate 39, a plurality of wavelength control layers 171, a light diffusing portion 170, and the light scattering layer 50. A plurality of wavelength control layers 171 are formed on one surface (a surface opposite to the viewing side) of the substrate 39. The light diffusing portion 170 is formed in a region other than the forming regions of the wavelength control layers 171 in one surface of the substrate 39. The light scattering layer 50 is formed on a surface on the viewing side of the substrate 39.

In the light diffusing film 167 of the third embodiment, a plurality of wavelength control layers 171 are provided on one surface of the substrate 39 in a dotted manner. A planar shape of the wavelength control layer 171 is an elongated elliptical shape when viewed from the normal line direction of the substrate 39. The wavelength control layer 171 has a long axis and a short axis. In the light diffusing film 167 of this embodiment, ratios of the length in the short axis direction with respect to the length in the long axis direction are approximately equal to each other in respective wavelength control layers 171. Though dimensions of a plurality of wavelength control layers 171 are different from each other, the length in the long axis direction is 20 μm and the length in the short axis direction is 10 μm, for example, as an example of dimensions of the wavelength control layer 171.

Portions below the wavelength control layers 171 are air-cavities 173 having an elliptical truncated cone shape. The light diffusing film 167 has a plurality of air-cavities 173. In a portion other than a plurality of air-cavities 173, the light diffusing portion 170 is integrally provided in a wall shape.

In the light diffusing film 167 of the third embodiment, the long axis directions of ellipses which are planar shapes of respective wavelength control layers 171 are approximately aligned in the X axis direction. The short axis directions of ellipses which are planar shapes of respective wavelength control layers 171 are approximately aligned in the Y axis direction. Accordingly, in terms of the direction of a lateral surface 170c of the light diffusing portion 170, a rate of the lateral surface 170c along the X axis direction is larger than a rate of the lateral surface 170c along the Y axis direction between the lateral surfaces 170c of the light diffusing portion 170. Therefore, light which is reflected at the lateral surface 170c along the X axis direction and is diffused in the Y axis direction is larger in quantity than light which is reflected at the lateral surface 170c along the Y axis direction and is diffused in the X axis direction. Accordingly, an azimuth direction in which a diffusion property of the light diffusing film 167 is larger is the Y axis direction which is the short axis direction of the wavelength control layer 171.

Examples of a planar shape of the wavelength control layer 171 may include a circular shape, a polygonal shape, a semicircular shape, and the like. The wavelength control layers 171 may be formed in a state in which portions of the wavelength control layers 171 are overlapped with each other, a portion of the wavelength control layer 171 may be missed, or an outline of the wavelength control layer 171 may be uneven. All of the wavelength control layers 171 may have identical dimensions and shapes to each other or dimensions and shapes of part of the wavelength control layers 171 may be different from each other.

In the liquid crystal display device of the third embodiment as well, such advantageous effect, which is similar to that of the first embodiment, can be obtained that light which is transmitted through the light diffusing film 167 is scattered by the light scattering layer 50, then beams of light of different colors are mixed, and as a result, iridescent unevenness can be suppressed.

Especially, according to the configuration of the third embodiment, the light diffusion property of the light diffusing film 167 includes in-plane anisotropy. Described by using the above-described example, the light diffusion property to the Y axis direction is higher than the light diffusion property to the X axis direction. Accordingly, a liquid crystal display device exhibiting excellent display quality can be provided by incorporating anisotropy of the light diffusion property of the light diffusing film 167 with a visual angle property in the azimuth angle direction of individual liquid crystal panel.

### Fourth Embodiment

A fourth embodiment of the present invention is described below with reference to FIG. 15.

The basic configuration of a liquid crystal display device of the fourth embodiment is identical to that of the first embodiment, but a position of a light scattering body is different from that of the first embodiment.

Accordingly, the description of the basic configuration of the liquid crystal display device is omitted in the fourth embodiment.

FIG. 15 is a sectional view illustrating the liquid crystal display device according to the fourth embodiment.

In FIG. 15, constituent elements common to those in the drawings which are used in the first embodiment are given identical reference characters and detailed descriptions thereof are omitted.

In a liquid crystal display device 181 of the fourth embodiment, light scattering bodies 52 are included in the substrate 39 having a birefringence, as illustrated in FIG. 15. Accordingly, the substrate 39 has a birefringence and further has a function to scatter incident light. Other configurations are same as those of the first embodiment.

In the liquid crystal display device 181 of the fourth embodiment as well, such advantageous effect, which is similar to that of the first embodiment, can be obtained that light which is transmitted through a light diffusing film 182 is scattered by the light scattering bodies 52 included in the substrate 39, then beams of light of different colors are mixed, and as a result, iridescent unevenness can be suppressed. Further, the light diffusing film 182 can be formed thinner than that of the first embodiment.

### Fifth Embodiment

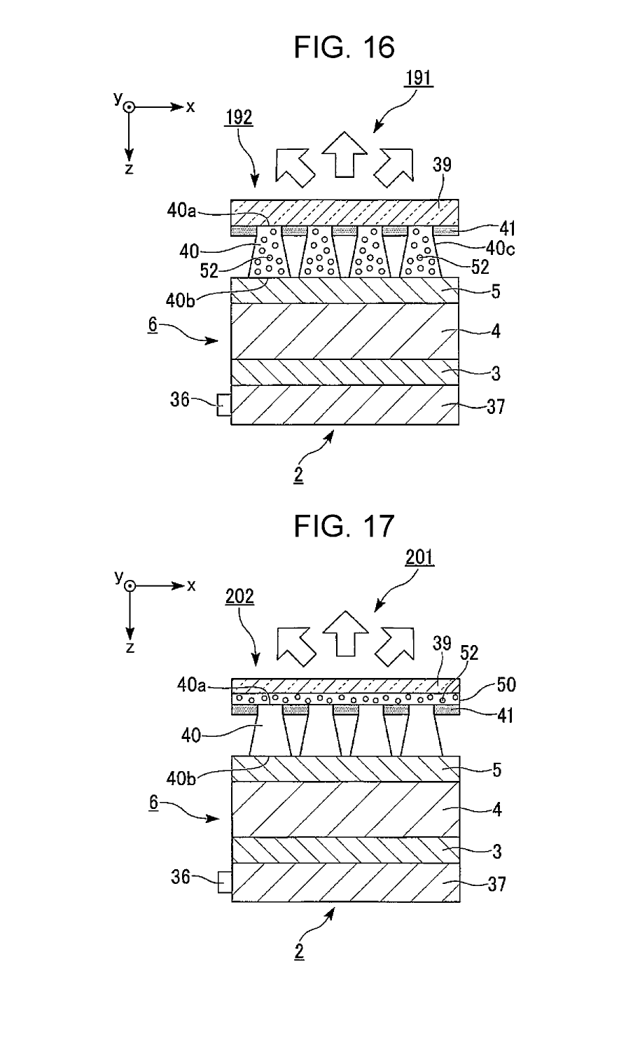

A fifth embodiment of the present invention is described below with reference to FIG. 16.

The basic configuration of a liquid crystal display device of the fifth embodiment is identical to that of the first embodiment, but a position of a light scattering body is different from that of the first embodiment.

Accordingly, the description of the basic configuration of the liquid crystal display device is omitted in the fifth embodiment.

FIG. 16 is a sectional view illustrating the liquid crystal display device according to the fifth embodiment.

In FIG. 16, constituent elements common to those in the drawings which are used in the first embodiment are given identical reference characters and detailed descriptions thereof are omitted.

In a liquid crystal display device 191 of the fifth embodiment, light scattering bodies 52 are included in the light diffusing portions 40, as illustrated in FIG. 16. The light diffusing portion 40 has functions to reflect incident light on the lateral surface 40c thereof and to scatter light traveling in the inside thereof.

In the liquid crystal display device 191 of the fifth embodiment as well, such advantageous effect, which is similar to that of the first embodiment, can be obtained that light which is transmitted through a light diffusing film 192 is scattered by the light scattering bodies 52 included in the light diffusing portions 40, then beams of light of different colors are mixed, and as a result, iridescent unevenness can be suppressed.

### Sixth Embodiment

A sixth embodiment of the present invention is described below with reference to FIG. 17.

The basic configuration of a liquid crystal display device of the sixth embodiment is identical to that of the first embodiment, but a position of a light scattering body is different from that of the first embodiment.

Accordingly, the description of the basic configuration of the liquid crystal display device is omitted in the sixth embodiment.

FIG. 17 is a sectional view illustrating the liquid crystal display device according to the sixth embodiment.

In FIG. 17, constituent elements common to those in the drawings which are used in the first embodiment are given identical reference characters and detailed descriptions thereof are omitted.

In a liquid crystal display device 201 of the sixth embodiment, the light scattering layer 50 including light scattering bodies 52 is formed between the substrate 39 having a birefringence and the light diffusing portions 40 and between the substrate 39 and the wavelength control layer 41 as illustrated in FIG. 17. In other words, the light scattering layer 50 is formed on the whole region of a surface, which is on a side on which the light diffusing portions 40 and the wavelength control layer 41 are formed, of the substrate 39, in a light diffusing film 202.

In the liquid crystal display device 201 of the sixth embodiment as well, such advantageous effect, which is similar to that of the first embodiment, can be obtained that light which is transmitted through the light diffusing portions 40 is scattered by the light scattering layer 50, then beams of light of different colors are mixed, and as a result, iridescent unevenness can be suppressed.

### Seventh Embodiment

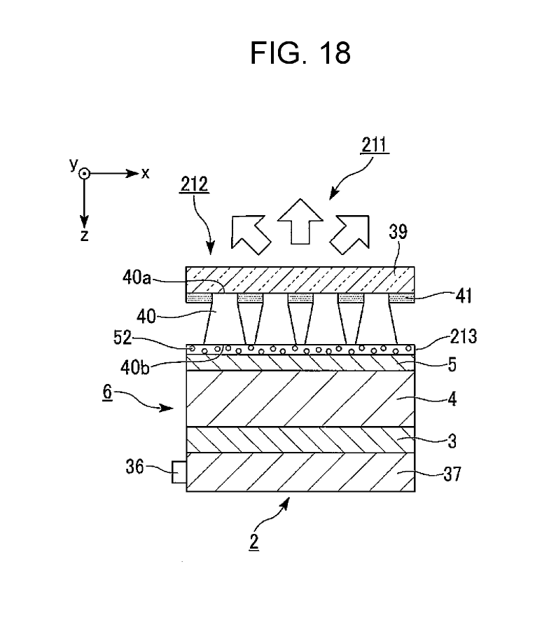

A seventh embodiment of the present invention is described below with reference to FIG. 18.

The basic configuration of a liquid crystal display device of the seventh embodiment is identical to that of the first embodiment, but a position of a light scattering body is different from that of the first embodiment.

Accordingly, the description of the basic configuration of the liquid crystal display device is omitted in the seventh embodiment.

FIG. 18 is a sectional view illustrating the liquid crystal display device according to the seventh embodiment.

In FIG. 18, constituent elements common to those in the drawings which are used in the first embodiment are given identical reference characters and detailed descriptions thereof are omitted.

In a liquid crystal display device 211 of the seventh embodiment, light scattering bodies 52 are included in an adhesive layer 213 which bonds a light diffusing film 212 and the liquid crystal display body 6 as illustrated in FIG. 18.

In the liquid crystal display device 211 of the seventh embodiment as well, such advantageous effect, which is similar to that of the first embodiment, can be obtained that light is scattered by the light scattering bodies 52 which are included in the adhesive layer 213 before the light is incident on the light diffusing film 212 and accordingly, iridescent unevenness can be suppressed.

### Eighth Embodiment

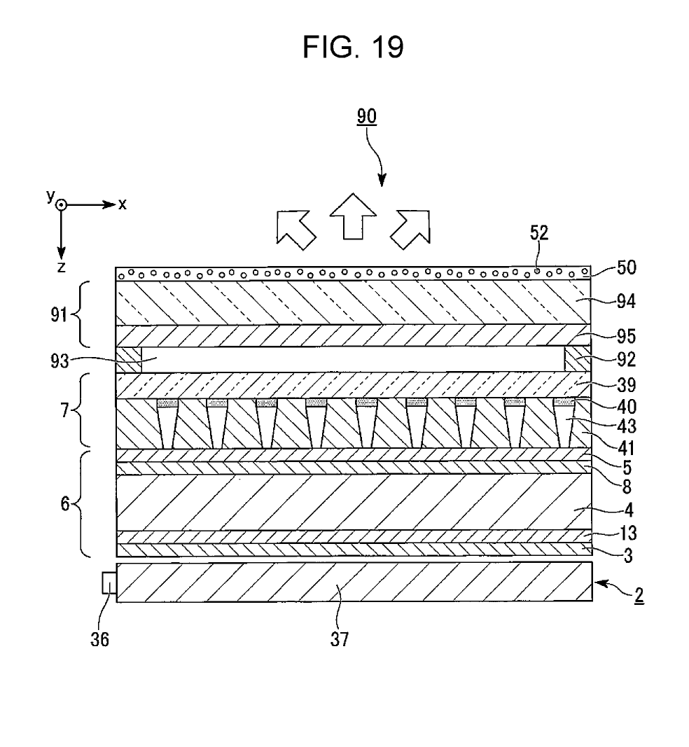

An eighth embodiment of the present invention is described below with reference to FIG. 19.

The basic configuration of a liquid crystal display device of the eighth embodiment is identical to that of the first embodiment, but the eighth embodiment is different from the first embodiment in that a touch panel is provided in the eighth embodiment. Accordingly, the description of the basic configuration of the liquid crystal display device is omitted and the configuration of the touch panel is described in this embodiment.

In FIG. 19, constituent elements common to those in the drawings which are used in the first embodiment are given identical reference characters and detailed descriptions thereof are omitted.

In a liquid crystal display device 90 according to the eighth embodiment, the configurations from the backlight 2 to the light diffusing film 7 are identical to those of the first embodiment as illustrated in FIG. 19. On the viewing side of the substrate 39 which constitutes the light diffusing film 7, a touch panel 91 is disposed. In the following description, the substrate 39 which constitutes the light diffusing film 7 is referred to as a “light-diffusing-film substrate”. The touch panel 91 is bonded on the light-diffusing-film substrate 39 by an adhesive material 92 such as a double-faced tape at a circumferential portion of the light-diffusing-film substrate 39. Between the touch panel 91 and the light-diffusing-film substrate 39, a gap corresponding to the thickness of the adhesive material 92 is formed. That is, between the touch panel 91 and the light-diffusing-film substrate 39, an air layer 93 exists.

The touch panel 91 includes a substrate 94 and a position detection electrode 95. In the following description, the substrate 94 which constitutes the touch panel 91 is referred to as a “touch-panel substrate”. On one surface of the touch-panel substrate 94 which is composed of a glass substrate or the like, the position detection electrode 95 which is made of a transparent conductive material such as ITO and antimony-doped tin oxide (ATO: tin oxide into which antimony is doped) is formed. The position detection electrode 95 is formed by spattering of ITO, ATO, or the like and has an even sheet resistance of approximately hundreds to 2 kΩ/□.

The light scattering layer 50 is provided on a surface, which is on the viewing side, of the touch-panel substrate 94. Even in a case where the light-diffusing-film substrate 39 has a birefringence, the light scattering layer 50 does not always have to be brought into contact with the light-diffusing-film substrate 39 which has a birefringence and may be positioned apart from the light-diffusing-film substrate 39 as long as the light scattering layer 50 is positioned on the viewing side more than the second polarizer 5.

In this embodiment, the capacitive touch panel 91 is used. In the capacitive touch panel 91, fine voltages are applied to four corner portions of the position detection electrode 95 in a planar view of the touch panel 91, for example. When an arbitrary position above the position detection electrode 95 is touched by a finger, a point which is touched by the finger is grounded via capacitance of a human body. Accordingly, voltages of respective corner portions vary depending on a resistance value between the grounding point and the four corner portions. A position detection circuit measures this voltage change as a current change so as to detect a grounding point, that is, a position which is touched by a finger depending on the measurement value.

Here, a touch panel which is applicable in this embodiment is not limited to the capacitive touch panel, but arbitrary touch panels such as those of a resistance film type, an ultrasonic type, and an optical type are applicable.

According to the liquid crystal display device 90 of this embodiment, the light scattering layer 50 is provided on the viewing side of the light diffusing film 7, so that a liquid crystal display device which suppresses generation of iridescent unevenness and further has an information input function can be realized. Information can be interactively inputted into an information processing device or the like by touching the touch panel 91 by a finger or a pen while a user looks at an image of a wide viewing angle, for example.

Here, the technical scope of the present invention is not limited to the above-described embodiments but various alterations can be made without deviating from the object of the present invention.

For example, in terms of the light diffusing film, the light diffusing portion and the wavelength control layer may be formed on the whole surface on the substrate having a birefringence or there may be a region, in which the light diffusing portion and the wavelength control layer are not formed, on a part of at least a circumference portion on the substrate. In this case, the light scattering layer is formed to have an area same as that of the forming region of the light diffusing portion and the wavelength control layer or the light scattering layer is formed to have an area larger than that of the forming region of the light diffusing portion and the wavelength control layer. The light diffusing film is bonded to the liquid crystal panel so that an edge of the forming region of the light diffusing portion and the wavelength control layer is positioned more outside than the edge of a display region of the liquid crystal panel.

Further, as for specific exemplification of arrangement, materials, shapes, dimensions, numbers, and the like of respective constituent elements which constitute the light diffusing film and the display device, arbitral alteration can be made.

### INDUSTRIAL APPLICABILITY

The present invention is applicable to various types of display devices such as a liquid crystal display device, an organic electroluminescence display device, and a plasma display.

### REFERENCE SIGNS LIST

1, 90, 101, 181, 191, 201, 211 liquid crystal display device (display device)
6 liquid crystal display body (display body)
7, 107, 167, 182, 192, 202, 212 light diffusing film (light diffusing member)
39 substrate
40, 140, 170 light diffusing portion
40a light emitting end surface
40b light incident end surface
41, 141, 171 wavelength control layer
50 light scattering layer (light scattering portion)

1: A light diffusing member comprising:
a substrate which has optical transparency and a birefringence;
a wavelength control layer which is formed one surface of the substrate;
a light diffusing portion which is formed in a region other than a forming region of the wavelength control layer in the one surface of the substrate; and
a light scattering portion, wherein
the light diffusing portion includes a light emitting end surface which comes into contact with the substrate and a light incident end surface which is opposite to the light emitting end surface and has a larger area than an area of the light emitting end surface, and a height from the light incident end surface to the light emitting end surface is larger than a layer thickness of the wavelength control layer.

2: The light diffusing member according to claim 1, wherein an in-plane retardation of the substrate is from 1000 nm to 4000 nm.

3: The light diffusing member according to claim 1, wherein the light scattering portion is provided on the other surface side which is opposite to the one surface of the substrate.

4: The light diffusing member according to claim 3, wherein the light scattering portion serves also as an antiglare treatment layer.

5: A display device comprising:
a display body; and
a viewing angle extending member which is provided on a viewing side of the display body and emits light in a state in which angle distribution of light which is incident from the display body is extended more than before the light is incident, wherein
the display device is composed of a light diffusing member in which
the viewing angle extending member includes
a substrate which has optical transparency and a birefringence,
a wavelength control layer which is formed one surface of the substrate,
a light diffusing portion which is formed in a region other than a forming region of the wavelength control layer in the one surface of the substrate, and
a light scattering portion,
the light diffusing portion includes a light emitting end surface which comes into contact with the substrate and a light incident end surface which is opposite to the light emitting end surface and has a larger area than an area of the light emitting end surface, and a height from the light incident end surface to the light emitting end surface is larger than a layer thickness of the wavelength control layer, and
the light scattering portion is disposed on any position on a light emitting surface side more than the display body.

6: The light diffusing member according to claim 2, wherein the light scattering portion is provided on the other surface side which is opposite to the one surface of the substrate.
